(19) United States
(12) Patent Application Publication
(10) Pub. No.: US 2019/0275510 A1
(43) Pub. Date: Sep. 12, 2019

(54) CATALYTIC CONVERTER RESTORATION SYSTEMS AND METHODS

(71) Applicant: Robert R. Marino, Villas, NJ (US)

(72) Inventor: Robert R. Marino, Villas, NJ (US)

(21) Appl. No.: 16/294,878

(22) Filed: Mar. 6, 2019

Related U.S. Application Data
(60) Provisional application No. 62/639,368, filed on Mar. 6, 2018.

(51) Int. Cl. B01J 38/68; B01J 23/96; B01J 23/92; B01D 53/96; B01D 53/94

(52) U.S. Cl. CPC B01J 38/68; B01J 23/96; B01J 23/92; B01D 53/96; B01D 53/94; B01D 2255/2063; B01D 2255/1023; B01D 2255/1025; B01D 2255/2092; B01D 2255/2065; B01D 2255/1021

(57) ABSTRACT

Apparatus and associated methods relate to restoring a catalytic converter to effective condition based on applying a vacuum to a first converter end, supplying restoration material to a second converter end to be atomized by the vacuum, and dispersing the atomized restoration material onto the catalytic converter substrate. In an illustrative example, the restoration material may be supplied through an atomization and induction fitting coupled with an open oxygen sensor port. Various embodiments may enrich the existing catalyst materials of a worn catalyst, with new catalyst materials which effectively restores original catalytic converter performance, in-place on a vehicle. In some embodiments, the vacuum source may be a vacuum cleaner. Various embodiments may include applying vacuum or vehicle operation for a time period effective to recondition the catalytic converter. Various examples may advantageously provide reduced cost converter restoration and improve access to functioning converters. Some embodiments may improve environmental quality by reducing the waste of replaced catalytic converters. Some implementations may be designed for a single use.

### CROSS-REFERENCE TO RELATED APPLICATIONS

This application claims the benefit of U.S. Provisional Application No. 62/639,368, titled “CATALYTIC CONVERTER RESTORATION SYSTEMS AND METHODS,” tiled by Applicant: Robert Marino, on Mar. 6, 2018; Inventor: Robert Marino.

This application incorporates the entire contents of the above-referenced application herein by reference.

### TECHNICAL FIELD

Various embodiments relate generally to catalytic converter restoration.

### BACKGROUND

Catalytic Converters are devices that convert certain regulated exhaust gasses into unregulated substances such as carbon dioxide gas and water. Government regulations, established decades ago, limit these exhaust emissions from combustion engines including those of automobiles. Catalytic converters were developed in order to comply with these limits and regulations. Some government regulations require that combustion engines, including automobile engines, are equipped with a catalytic converter configured to limit damage to the natural environment by regulated exhaust gases. Catalytic converters are now commonly used on motor vehicles and engine powered equipment in the USA, as well as most of the developed world.

Some new automotive catalytic converters may be designed to operate effectively for as long as 10 years and/or 180,000 miles, when many catalytic converters may become substantially deteriorated or no longer functioning. Computerized onboard diagnostic systems on some motor vehicles may detect poor catalytic converter performance. In some scenarios, when a computerized onboard diagnostic system detects that a catalytic converter may be performing poorly, the computer may initiate a check engine warning, and store a universal fault code for retrieval by a mechanic or inspection authority. In some scenarios, a typical fault code indicative of a failed catalytic converter is named “P0420.” US-EPA rules require that all vehicles have a functioning catalytic converter, and when the PO420 code is detected, that catalytic converter has failed. Operation of a combustion engine with a failed or ineffective catalytic converter causes the engine to emit toxic gases into the atmosphere and is dangerous to the natural environment. When a combustion engine's catalytic converter fails, reducing the engine's toxic exhaust gas emissions to regulated levels may require replacing the failed catalytic converter.

Replacing a catalytic converter system is extremely expensive, and a substantial burden on motorists when it becomes necessary to do so. In exemplary prior art usage scenarios, the only way to bring the exhaust emissions back down to required levels may be to remove and replace the poorly functioning catalytic converter with a new or fully functioning replacement. It is extremely expensive (a thousand or more dollars installed) to replace converters with even aftermarket replacements. Typically replacing a catalytic converter system is an unexpected expense, and the amount so financially burdensome, that it can substantially affect an average household's ability to meet other basic household needs. Failure to replace the converter and subsequently pass a required emissions inspection test, may result in substantial fines or, inability to drive the vehicle until repairs can be made.

Catalytic Converter devices convert harmful exhaust gasses into harmless carbon dioxide and water before reaching the atmosphere. This conversion process occurs within a highly engineered and compact honeycomb channeled element inside of the converter enclosure. A critical device mounted within a converter enclosure is often described as a “Catalyzed Substrate Element.” This Catalyzed. Substrate Element may be a flow-through element (honeycomb like structure) which may have a large number of channels that exhaust gas may flow through, combining results in a surface area that may be extremely large. These channels can be catalytically treated by coating them with specialized materials. In some scenarios, such a catalytic coating on these surfaces may react with and purify exhaust gas that may come in contact with the catalytic coating.

A functioning catalytic converter system may include three major components. In an illustrative example, catalytic converter components may include: An internal substrate element, catalytic coating materials, and the substrate enclosure with attachments.

1. The “Catalyzed Substrate Element”: A flow-through porous element which appears as a compact honeycomb like structure which results in a large contact surface area. This surface area is treated with specialized catalytic materials. Exhaust gas flowing through the channels contact the catalytic material, and pollutants are transformed in the process.

2. “Catalytic Materials”: These are proprietary material formulations often containing precious metals and other rare materials. These materials are applied to the fresh new substrate element thus infusing into and coating onto its surfaces. These materials are critical to transforming a new non-functional Substrate Element, into a functional “Catalytic Substrate Element”.

3. “Substrate Enclosure and Enclosure Attachments” (the “Can”) are metal components that provide a practical containment for the substrate, and also the tubes, attachment mechanisms, sensor ports, and other adaptations for the practical application of the catalyst technology.

### SUMMARY

Apparatus and associated methods relate to restoring a catalytic converter to effective condition based on applying a vacuum to a first converter end, supplying restoration material to a second converter end to be atomized by the vacuum, and dispersing the atomized restoration material onto the catalytic converter substrate. In an illustrative example, the restoration material may be supplied through an atomization and induction fitting coupled with an open oxygen sensor port. Various embodiments may recondition a catalytic converter in-place on a vehicle. In some embodiments, the vacuum source may be a vacuum cleaner. Various embodiments may include applying vacuum or vehicle operation for a time period effective to recondition the catalytic converter. Various examples may advantageously provide reduced cost converter restoration and improve consumer access to functioning converters. Some embodiments may improve environmental quality by reducing the waste of replaced catalytic converters. Some implementations may be designed for a single use.

Some embodiments may provide a cost effective catalytic converter recoating method that uses restoration materials, a material application apparatus/kit, and a unique heat-treating method that when used together, restores a high level of operational performance to a worn out or nonfunctioning catalytic converter element (catalyst substrate).

Some embodiments may be designed to facilitate Catalyst Substrate Restoration “insitu” with the catalytic converter still installed on the vehicle (or any combustion engine exhaust system). Using various embodiment methods or apparatus, a catalyst substrate restoration may be performed by a general auto mechanic without the need for specialized equipment or facilities. In various implementations, embodiments of the present invention may be presented as a kit which may include a Proprietary Combination of Restoration Materials, a Disposable Application apparatus, application Methodology, and Heat-treating methodology.

Some embodiments of the present invention may include a novel technique to heat Treat (calcine/bake) the restoration materials onto the catalytic converter element insitu, without the need for special industrial heat-treating equipment. Calcination is known to be a necessary step in the processes of activating and stabilizing catalytic coating materials of the type disclosed.

Some embodiments of the present invention may provide a single use kit and system for application to disperse specialized atomized fluid slurries into a typical motor vehicle's oxygen sensor port, which may be located on the exhaust pipe at a point upstream of the catalytic converter. This may be done on the vehicle without exhaust system removal. Some systems in accordance with embodiments of the present invention may include using a common Shop vacuum according to directions in conjunction with the single use kit. The shop vacuum may be attached to the tail pipe of the vehicle, and thus may maintain a high velocity air flow and hard vacuum within the entire exhaust system. This vacuum is only relieved at the site of the open oxygen sensor port located upstream of the catalytic converter. As such there will be a high flow of ambient air under vacuum, being drawn into and through the oxygen sensor port. At the moment the ambient air being drawn into the catalytic converter reaches the port, the air velocity increases, and the pressure drops dramatically to a vacuum state. Note that in various embodiments, the port may be different sizes. For example, in some embodiments, the port may be 19 mm diameter. In various designs, the port may be 17 mm diameter. In some implementations, the port may be ⅝″ diameter. In various embodiments, the port may he circular. In some designs, the port maybe non-circular. With the Induction Fitting also referred to as the atomization fitting inserted into that open oxygen sensor port under those conditions, and liquid is introduced into the negative-pressure air flow occurring within the induction fitting, the liquid will be instantly atomized and drawn in the direction of the air flow at high velocity. In addition, this action may also begin self-feeding the fluid from the bottle, with a siphoning action through the dispensing tube, and ultimately into the interior area of the atomization fitting. Doing so disperses the atomized liquid into the exhaust pipe. In various examples, the exhaust pipe diameter may vary widely. In some examples, a typical exhaust pipe may have a 2″ diameter. The vacuum creates a continuous high velocity air flow which carries the atomized fluid downstream where it is deposited onto the face of the honeycomb channeled substrate. The continuously moving airflow draws the fluid into the channels where it is completely absorbed into and deposited onto the substrate. The amount of liquid in the bottle is determined and is therefore fully utilized within the catalyst substrate element. There is no waste or need to capture or recycle excess fluid. A particularly useful feature of various embodiments of the present invention is the ability to perform the rejuvenation/activation while the spent catalytic converter is still on the motor vehicle, by any mechanic. Embodiments of the present invention provide a fast and inexpensive option to removal, purchase and reinstallation of extremely expensive new catalytic converter systems.

Various embodiments may achieve one or more advantages. For example, some embodiments may improve a user's compliance with applicable US-EPA requirements and other government regulations. This facilitation may be a result of reducing the user's effort and cost to replace a failed or worn out catalytic converter. In some embodiments, the financial burden of catalytic converter replacement may be reduced. Such financial burden reduction may be a result of providing a consumer with access to a more affordable option to restore a failed catalytic converter to effective operation. For example, some embodiments may restore functionality of a non-performing converter at a fraction of the cost of replacing the failed converter. Some embodiments may reduce a user's exposure to toxic exhaust. This facilitation may be a result of increased availability to the general public of low cost catalytic converter restoration.

Some embodiments may improve the quality of the environment. This facilitation may be a result of increased access to catalytic converter restoration that may be performed by an average auto mechanic or even a mechanically inclined vehicle owner, without the need for specialized training or equipment. Some embodiments may reduce the required repair time for a vehicle with a failed catalytic converter. Such reduced repair time may be a result of restoring a failed catalytic converter to effective operation without uninstalling the failed catalytic converter from a vehicle. Some examples may reduce toxic waste in the natural environment. This facilitation may be a result of restoring existing catalytic converters, instead of installing a replacement and disposing the failed converter in a landfill.

Some embodiments of the present invention may repair and restore function to a catalytic converter, by easily and effectively depositing specialized catalytically restorative materials onto the surface of the non-functional internal catalyst element (substrate). Various implementations of embodiments of the present invention may restore the internal catalyst element (substrate) while still mounted and encased within its protective catalytic converter shell, and while the shell itself is still mounted on a vehicle or an engine exhaust system. In exemplary scenarios of usage of some embodiments of the present invention, catalytic converter restoration may be accomplished at very low financial cost by a general auto mechanic or home handyman, without the need for specialized equipment.

Comparing (A) the conventional cost to have worn out motor vehicle catalytic converter removed and then replaced at a typical vehicle mechanic shop, with (B) the cost of having the restoration technology disclosed applied at a typical vehicle shop; shows a 75% cost reduction to restore. Some embodiments of the restoration method disclosed may provide an alternative that is orders of magnitude less expensive and provides meaningful financial relief to consumers. Approximately 3 million motor vehicle catalytic converters are replaced in the USA each year at a cost between $800.00 and 1600.00 each. This amounts to (2.4 and 4.8 billion dollars) cost to consumers. Based upon an estimated restoration cost of $200.00, some embodiments of the invention may reduce that cost to ($600 million and 1.3 billion dollars). The potential annual savings to consumers is dramatic and is sufficient to have meaningful large scale financial impacts. In addition, replacement catalytic converter systems weigh ˜10 to 20 pounds each. Ideally, by repairing rather than replacing all the systems, the load on natural resource consumption is reduced by 30 to 60 million pounds of metal and other materials per year in the USA alone.

Various embodiments of the present invention may include a restoration system that can be applied to any exhaust gas system having a catalytic converter, such as motor vehicles and stationary engine powered systems, and industrial process exhaust systems.

### SUMMARY OF FEATURES

1. Some embodiment single use restoration kit systems may facilitate induction, atomization, transfer, and dispersion of a predetermined amount of (proprietary) materials (in liquid or slurry form) into an open oxygen sensor port (or hole) of an internal combustion engine exhaust system, with the purpose of transferring the material further along the inside length of a pipe, where it is ultimately deposited onto a catalytic converter substrate element located (Upstream or Downstream) of the dispersion point.
2. Various embodiment system and method implementations may keep dispersed materials airborne within an exhaust pipe, thus allowing the materials to travel effectively within the exhaust pipe to the intended destination, which is sometimes located a substantial distance away from the introduction point.
3. In an illustrative example, some embodiment systems may be designed to apply restoration fluid, without the need to remove the converter, or the exhaust system from the vehicle, and while the converter is still sealed within its permanent enclosure.
4. Various embodiment system designs do not require an external heat source in order to calcine/heat treat the deposited fluid. In an example illustrative of some embodiments' usage, the vehicle engine's hot exhaust may perform the calcine/heat treating task while operating according to disclosed instructions, and subsequently under normal engine operating conditions.
5. Some restoration system embodiments can be applied to restore catalytic converter function by anyone capable of removing the oxygen sensor from the automobile's exhaust system or drilling a hole.
6. In an illustrative example, various embodiment implementation designs may facilitate restoring catalytic converter function without elaborate laboratory or industrial equipment, facilities or specialized personnel.
7. Some embodiment system designs may provide a practical and affordable means to consumers which extraordinarily reduces the cost currently associated with replacing a catalytic converter.
8. Various embodiment system implementations may provide a legitimate alternative to consumers who may otherwise consider using diagnostic system “Defeat” or “Cheat” methods, due to their inability to buy a new converter replacement at that moment.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an operational view of an embodiment catalytic converter restoration apparatus restoring a catalytic converter to effective condition based on applying a vacuum to a first converter end, supplying restoration material to a second converter end to be atomized by the vacuum, and dispersing the atomized restoration material onto the catalytic converter substrate.

FIG. 2 depicts an operational view of an alternative embodiment catalytic converter restoration apparatus restoring a catalytic converter to effective condition based on applying a vacuum to a first converter end, supplying restoration material to a second converter end to be atomized by the vacuum, and dispersing the atomized restoration material onto the catalytic converter substrate.

FIG. 3 depicts the design and use of an exemplary fluid dispenser and tube attachment fitting.

FIG. 4 is a flow diagram depicting exemplary flows of Induced Fresh Air, Negative Pressure, and Atomized Mixture Flow, due to an exemplary induction atomization fitting mating to an exemplary Oxygen Sensor Port disposed on an engine exhaust pipe.

FIG. 5 depicts a top view of an exemplary fluid dispersing fitting atomizing restoration fluid.

FIG. 6 depicts a side view of an exemplary fluid dispersing and atomizing fitting atomizing restoration fluid.

FIG. 7 depicts a side view of an exemplary fluid dispersing and atomizing fitting.

FIG. 8 depicts an operational view of an alternative embodiment catalytic converter restoration apparatus with 90-degree Low Exit Point Dispenser Nozzle restoring a catalytic converter to effective condition based on applying a vacuum to a first converter end, supplying restoration material to a second converter end to be atomized by the vacuum, and dispersing the atomized restoration material onto the catalytic converter substrate.

FIG. 9 depicts an exemplary 90-degree Low Exit Point induction fitting.

FIG. 10 depicts an exemplary Straight Flow induction fitting.

FIG. 11 depicts a schematic view of an exemplary Straight Flow induction fitting illustrating the fitting Atomizing restoration material.

FIGS. 12A-12C depict various perspective views illustrative of exemplary Atomizing induction Fitting attachment designs.

FIGS. 13A-13B depict back and front views of an exemplary 90 Degree Angle Delivery Nozzle with Mid-Level Exit Point.

FIGS. 14A-14B depict back and front views of an exemplary 90 Degree Angle Dispensing Nozzle with Low Exit Point.

FIGS. 15A-15B depict front and top views of an exemplary 90 Degree Angle Induction Fitting with Mid-Nozzle Exit Point.

FIG. 16 depicts a top view of an exemplary 90 Degree Induction Fitting Dispenser.

FIGS. 17A-17C depict various perspective views of exemplary Fluid Transfer Tube and Injector Barb designs.

FIG. 18 depicts an exemplary Fluid Dispenser Trigger Pump and Fluid Container with a connected Fluid Transfer Tube.

FIGS. 19A-19B depict various schematic views of an exemplary On-Vehicle Catalyst Recoating System Using Drilled Holes for Vacuum Nozzle and Induction Fitting and Multi-Direction Catalyst Coating.

FIGS. 20A-20E depict various assembly views illustrative of an exemplary On-Vehicle Recoating System using Drilled Holes in the Exhaust Pipe, an exemplary Universal Hole Patch, and an exemplary Vacuum Hose to Nozzle Insert Adapter Assembly.

FIGS. 21A-21B depict various assembly views of an exemplary Vacuum Nozzle Adapter, Flexible Hose, and Suction Nozzle.

### DETAILED DESCRIPTION OF ILLUSTRATIVE EMBODIMENTS

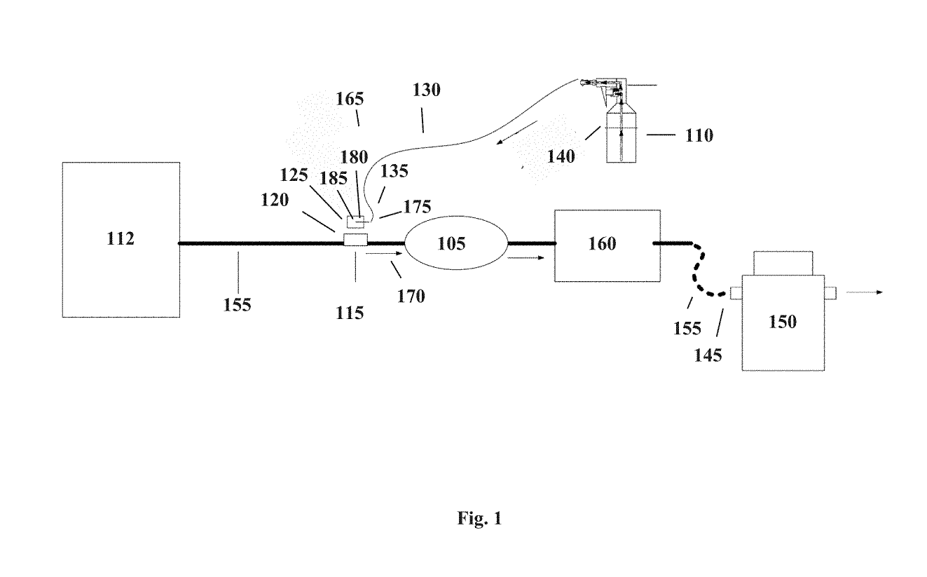

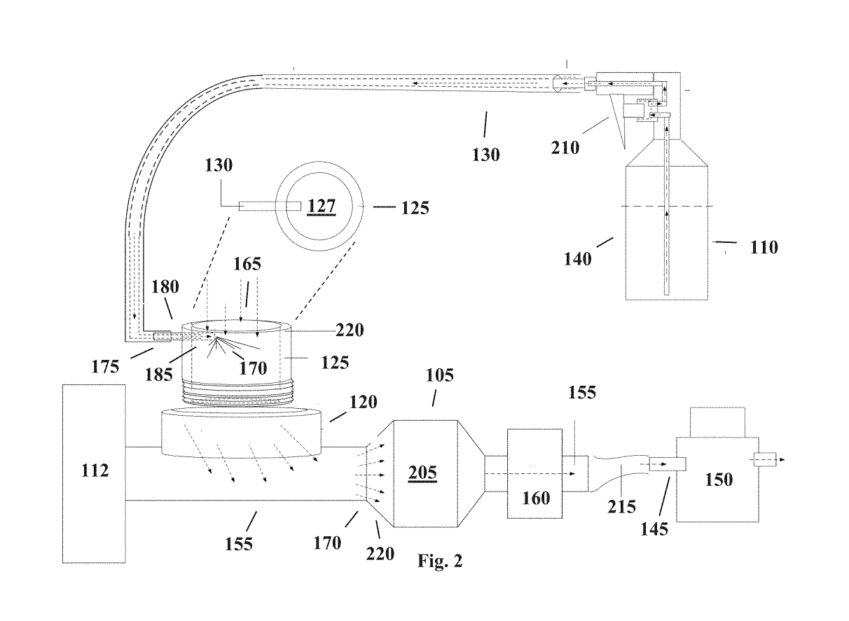

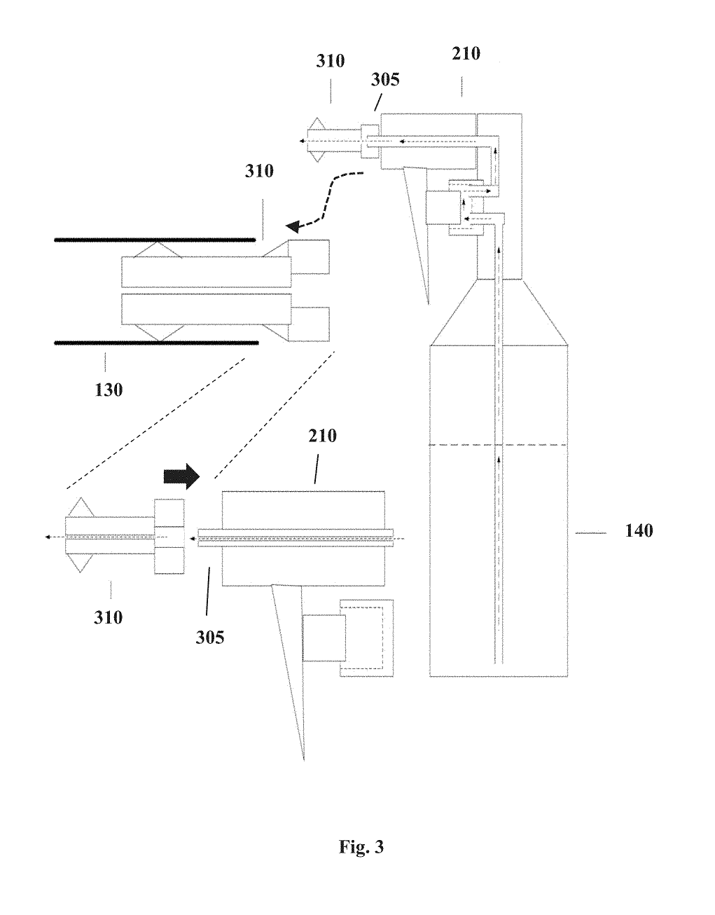

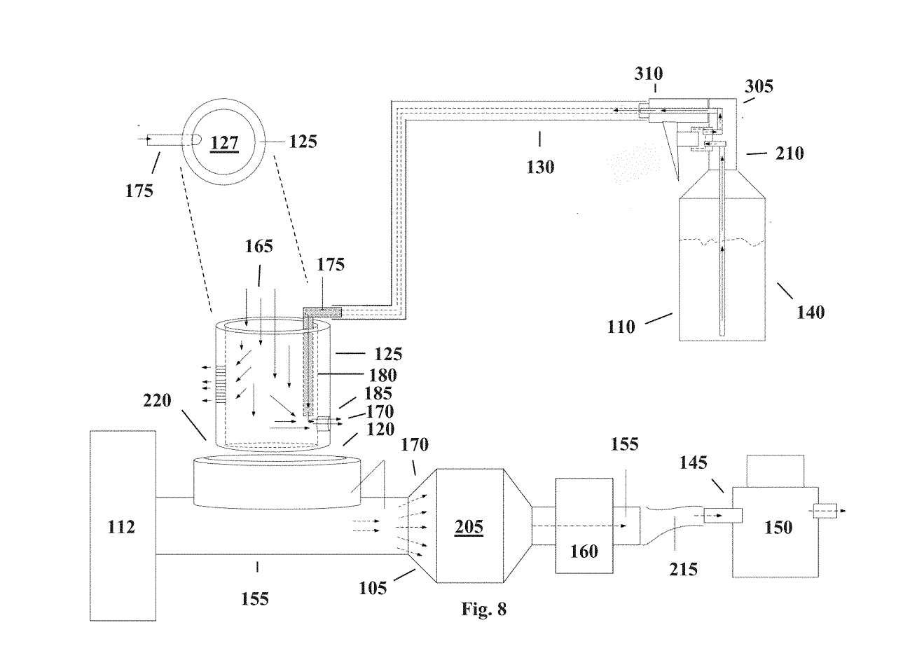

To aid understanding, this document is organized as follows. First, novel apparatus and methods to restore and recondition catalytic converters based on applying a vacuum to a first converter end, supplying restoration material to a second converter end to be atomized by the vacuum, and dispersing the atomized restoration material onto the catalytic converter substrate, are briefly introduced with reference to FIGS. 1-2. Then, with reference to FIGS. 3-7, the discussion turns to exemplary embodiments that illustrate the design, construction, and usage of various catalytic converter restoration apparatus components. Specifically, the design and usage of an embodiment fluid dispenser, tube attachment, and fluid dispersion fitting, are disclosed. Finally, with reference to FIGS. 8-21, embodiment designs disclosing improvements in catalytic converter restoration system components and restoration materials are described.

FIG. 1 depicts an operational view of an embodiment catalytic converter restoration apparatus restoring a catalytic converter to effective condition based on applying a vacuum to a first converter end, supplying restoration material to a second converter end to be atomized by the vacuum, and dispersing the atomized restoration material onto the catalytic converter substrate. The apparatus depicted in FIG. 1 is a single-use kit implementation of an embodiment of the invention. In the embodiment depicted by FIG. 1, to restore the catalytic converter 105 based on dispersion of activation materials 110, the expired or spent internal element contained within the catalytic converter 105 installed in the engine 112 exhaust system is re-coated with specialized activation materials 110 using the disclosed devices and system. In an illustrative example:
1) The upstream oxygen sensor 115 on the depicted exhaust system is removed which reveals a threaded female sensor port 120 (alternatively, a hole can be drilled into the exhaust pipe upstream of the catalytic converter 105).
2) A specially designed Induction Fitting also called an induction assisting fitting 125 is inserted into the sensor port 120.
3) One end of the flexible dispensing tube 130 is attached to the mounting point provision 135 located on the induction assisting fitting 125.
4) The other end of the flexible dispensing tube 130 is fluidly connected to the fluid dispenser bottle 140 containing the activation materials 110. In the depicted embodiment, the activation materials 110 include specialized catalyst materials. In various examples, the activation materials 110 may be referred to as restoration material.
5) A strong vacuum 145 (such as provided by the shop vacuum 150) is applied to the exhaust pipe 155 of the exhaust system through the existing muffler 160.
6) Then vacuum 145 pulls a stream of air 165 through the induction fitting 125 attached to the exhaust system upstream of the catalytic converter 105.
7) The venturi effect resulting from the stream of air 165 flowing across the induction fitting 125 and into the exhaust pipe 155, pulls restoration material 110 including catalytic fluid from the fluid dispenser bottle 140 and through the flexible dispensing tube 130, then into the induction fitting then travels into the exhaust system tubing, where it is ultimately delivered as an atomized fluid 170 into the catalytic converter 105.
8) The now atomized fluid 170 travels with the stream of air downstream to the catalytic converter 105 element.
9) The continuous mist stream then inundates the catalytic converter 105 element where it is absorbed into, and lodges onto the vast surface area contained by the honeycombed channeled or porous catalyst substrate element.
10) This action continues until substantially all of the restoration material 110 fluid within the fluid dispenser 140 is delivered into the catalyst substrate element.
11) The vacuum 145 is applied for some period of time after all of the restoration material 110 fluid has been dispersed. This step partially or completely dries the liquid that was dispersed on the catalytic element, such that the freshly dispersed liquid materials are sufficiently stabilized on the element and will no longer move.

Various embodiments of the present invention depicted in FIG. 1 may be provided as a catalytic converter restoration kit, which may include:
1) A restoration material reservoir: In some examples, the restoration fluid reservoir may be a common bottle such as, the depicted fluid dispenser bottle 140. In some examples, the bottle may have a volume sufficient to retain ten ounces of restoration material 110.
2) Restoration Material: In some embodiments the Restoration Material 110 may be a fluid referred to as Restoration Fluid. In various exemplary scenarios of use, the Restoration Material 110 may exist in various states in accordance with fluid dynamic properties of the apparatus, including the fluid dynamic state of restoration material within the apparatus during active use or inactive deployment or transport of such apparatus. For example, in various scenarios, Restoration Material 110 may exist in any state of matter such as may be known in the art, for example, solid, liquid, gas, or a mixture of any or all of a solid, liquid, or gas. In some embodiments, the Restoration Material 110 may be a specialized slurry of material having catalytic properties.
3) Trigger Pump: Capable of pumping slurry of material thicker than water
4) flexible Tubing: configured to transfer fluid from the trigger pump to the induction fitting 125. In some embodiments, the flexible dispensing tube 130 may be a ¼″ diameter tube.
5) Induction Fitting: Fluid atomization and induction fitting 125 capable of atomizing and mixing the relatively thick liquid slurry received from the dispensing tube 130. The fluid atomization and induction fitting 125 atomizes and mixes the restoration material 110 with flowing air 165 before the mixture enters the exhaust tube interior.
6) Fluid Injection Tube and Dispersing Nozzle: In some embodiments, the fluid injection tube 175 may be a 3/16″ diameter tube, ˜2-⅝″ long × 3/16″ outside diameter × 1/16″ inside diameter, with provision to introduce a liquid to the tube inside diameter. In various embodiment implementations, the fluid injection tube 175 may be fluidly connected with the dispersing nozzle 180 configured to disperse restoration material atomized at the discharge point 185.
7) Vacuum source: pulls a high-volume air flow through the open port 120 coupled with one end of the catalytic converter 105, under a strong vacuum 145 (supplied by either the kit user, or the kit supplier). In some embodiments, the open port 120 may be the O2 sensor port, with the O2 sensor removed.

Exemplary Restoration Material Composition: Various embodiments of the present invention may include Restoration Material 110 that may be a water-based slurry or materials in SOL form. In a preferred embodiment, the water-based slurry as a category can be described as: a water-based slurry, comprised of multiple types of suspended precious oxide particles, rare earth oxide particles, or compound-rare-earth-oxide particles, Zeolite particles, precious metals, and or semiprecious metals, and or transition metals, individually or in combination with each other. In addition, any of these materials may be included into a composite mixture, or may be dispensed individually, in a chemical precursor form, oxide, or elemental form. The preferred rare earth oxides include Alumina, Ceria, Zirconia, Lanthanum, yttrium, Titanium. These materials may also be used as combined compound oxides particle such as, for example, Alumina-Ceria-Zirconia Oxide. In an illustrative example, some of the materials can also be used in SOL gel form to prepare restoration Material formulations. Note: A preferred precious oxide is a dry rare earth oxide or compound oxide or mixture of oxides which have been pre-impregnated with stabilized precious metal prior to inclusion into slurry or mixture. Some preferred precious metals include Palladium, Platinum, Rhodium, and ruthenium. Other useful materials include barium and, vanadium, in precursor or elemental form. Other less effective transition metals capable of promoting catalytic oxidation or reduction may also be used for this purpose.

Introducing restoration material 110 into the exhaust system: Introducing the restoration material 110 into the exhaust system may be achieved using the kit's restoration material 110 atomization and induction fitting 125. Restoration material 110 is delivered to the atomization and induction fitting 125 where the restoration material 110 is further dispensed into an open oxygen sensor port 120. In some embodiments, the atomization and induction fitting 125 may be designed to be placed into one of the existing oxygen sensor ports which are typically located on the exhaust system pipe near an existing catalytic converter.

O2 Sensor Ports/Other Access Ports: In some embodiments, using an existing O2 sensor ports over another is preferred, and is typically situated upstream and in close proximity to the target catalytic converter. Alternatively, a hole can be drilled in the pipe at a convenient location near to the catalytic converter and can also be used to accept the atomization and induction fitting 125. In this situation, drilled holes can be plugged after the restoration is complete.

Transporting material within the exhaust pipe: Once the restoration material 110 is introduced into the open port 120, suction applied by a common shop vacuum cleaner, draws the restorative materials into the port or hole creating an atomized moving stream of restorative material mist and air, and traveling toward the targeted internal catalyst substrate and vacuum source.

Applying the material to the internal catalyst substrate element: The resulting flow of material laden moving air is ultimately delivered downstream to the catalytic converter situated between the material introduction point and the vacuum source. The catalyst substrate element interrupts the flow of solid and liquid materials carried in the air. These materials become permanently attached to this highly porous surface area of the internal catalyst substrate. All of the restoration materials are captured by the catalyst element, and nothing needs to be recaptured.

Air Suction: In some embodiments, the required suction may be achieved using a common shop vacuum cleaner or other air suction method, which may be attached to the outlet point of the tail pipe after removing the oxygen sensor from the port, and prior to inserting the fluid induction fitting supplied with the kit.

Technical description of Process: In an illustrative example, some embodiments of the present invention may provide a method or apparatus designed to facilitate transforming the stream of liquid restoration fluid/slurry, into a predominantly atomized mist contained within a fast-moving stream of flowing air under vacuum. The transformation occurs immediately when the liquid stream enters the induction fitting 125 which is inserted into the open port in the exhaust pipe. When the liquid restoration fluid meets the low pressure fast moving air stream conditions in the induction fitting 125 it becomes atomized and moves rapidly into the larger exhaust tube along with the air stream. The result is a wet stream of restoration material laden air, moving rapidly within the exhaust pipe toward the vacuum source. Ultimately, the flow of restoration material and air is interrupted by the internal catalyst element. The liquid and solid restoration components contained in the air-mist mixture are gradually trapped while traveling through hundreds of small elongated channels in the catalyst element. The materials adhere to, and in the case of ceramic substrates, also absorbed into the vast surface area contained within the substrate channels. The remaining dry air, is now stripped of restoration material constituents, flows toward the vacuum source and is vented to atmosphere.

Drying and Heat Treating: Once deposited onto the surface of the catalytic converter element (substrate); the materials require drying and heat treating in order to transform any precursors to fully functional elemental states and stabilize the oxides. This is the drying and calcination phase of the restoration. Drying and calcining similar types of materials used in catalytic converter manufacturing, require sophisticated drying and calcination furnaces situated in a factory environment. The novel method disclosed here uses the heat contained in the engine exhaust flow from the same engine attached to the exhaust system catalyst being restored, to dry and calcine the restoration materials. When operated according to the restoration method disclosed, the engine can supply hot exhaust gas at temperature up to 500 degrees C. and equal to those of a factory situated calcining furnace used for this purpose.

Summary of Exemplary Restoration Procedure: Attach a common shop vacuum cleaner to an engine exhaust tail pipe. Using the trigger pump, transfer restoration fluid from the bottle, into the tube and into the induction fitting. Introduce a fluid including the (Proprietary) restoration material (at atmospheric pressure) into an open oxygen sensor port (now under vacuum) located on a typical (i.e. 2″) exhaust pipe (also under vacuum). Allow all of the premeasured restoration material in the bottle, to be drawn into the induction fitting and down into the exhaust pipe After the restoration fluid is dispensed into the exhaust pipe, allow the vacuum cleaner to remain on for a short period (i.e. 1-2 minutes) in order to thoroughly distribute the material onto the catalyst substrate. The catalyst substrate is now inundated and coated with the restoration materials. Turn off and disconnect the Vacuum source and attach an exhaust vent tube if necessary. Reinstall the oxygen sensor port and start the vehicle engine. Allow the engine to operate at idle speed for ˜5 minutes or sufficient time to dry out the wet materials previously deposited into the catalyst substrate element. Drive the vehicle on the road at engine speed greater than idle. Operating the engine under condition sufficient to generate exhaust gas ˜250 degrees Celsius or higher for ˜10 minutes will activate the restoration materials and restore catalytic converter activity. For a typical motor vehicle, this would translate to driving at 40 mph for ˜10 minutes. Subsequent operation of the engine up to 1 hour under typical highway conditions will generate the higher temperatures necessary to fully stabilize the applied materials for long term durability.

Exemplary Calcination procedure: After the coating process is complete, the vehicle is started and then operated at idle speed for approximately 15 minutes. During this time, the initial temperature of the slow flowing exhaust gas slowly rises (reducing thermal shock to the restoration materials) and begins to dry the wet restoration materials deposited onto the catalytic substrate. After drying for 15 minutes, the vehicle is then operated on the road or under load at 40 MPH for approximately another 10 minutes. When operating the vehicle on the road at 40 mph or higher, exhaust gas temperature at the catalyst element can reach between 250 and 500 degrees Celsius or higher. In some scenarios exemplary of various embodiment usage, conditions such as these are sufficient to activate and fully stabilize the restoration materials for long term durability. After being subjected to such temperature for even a short period (i.e. ˜10 minutes) the converter will be catalytically functional. Additional engine operation under normal driving conditions up to 1 hour; further stabilizes the materials to a maximum durability state. It is important to note that coating new uncoated catalyst substrates with the type materials disclosed here, are currently only conducted in specialized manufacturing or laboratory facilities. As such, the required drying and heat-treating processes are done in specialized industrial drying ovens and high temperature (i.e. 500 degrees Celsius) heat treating kilns.

Reversing the flows: Since there is typically an existing oxygen sensor port conveniently positioned Upstream and Downstream of a catalytic converter, it is possible to reverse the positions of the vacuum source and the restoration fluid induction points. Contrary to the technique described previously, this means that vacuum can be applied (using an adapter) to the upstream oxygen sensor port, and the fluid can be introduced into the Downstream Oxygen sensor port. This reversed operation technique will disperse the restoration materials into the back side of the internal catalyst element instead of the front and will then be drawn by the vacuum source forward towards the front of the internal element instead of the back. This technique may be useful where large catalytic converter enclosure houses 2 or more individual catalyst substrates. These catalyst elements are typically separated in the enclosure housing by an air gap between them (i.e. 1 inch). An air gap between two substrates will hinder the movement of restoration fluid from the first substrate to the second or third substrate elements.

Drilled Holes in Exhaust System: Holes can be drilled into the exhaust system up stream or downstream of the internal catalyst element at any convenient point, instead of using existing oxygen sensor ports. This method would be useful if a preexisting oxygen sensor port is not conveniently located as described in the preferred method. The drilled holes can be plugged after the fluid introduction is complete by using any appropriate method.

FIG. 2 depicts an operational view of an alternative embodiment catalytic converter restoration apparatus restoring a catalytic converter to effective condition based on applying a vacuum to a first converter end, supplying restoration material to a second converter end to be atomized by the vacuum, and dispersing the atomized restoration material onto the catalytic converter substrate. In the embodiment depicted by FIG. 2, the exemplary restoration apparatus is configured to disperse the restoration material 110 onto the catalytic converter 105 substrate 205 located within the catalytic converter 105 which is installed in the engine 112 exhaust pipe 155. In the illustrated embodiment, the restoration material 110 is dispensed from the fluid dispenser bottle 140 as the spray trigger 210 is activated. In the depicted embodiment, the dispensed restoration material 110 flows through the dispensing tube 130 under substantially atmospheric conditions into the fluid atomization and induction fitting 125 installed in the sensor port 120. In the illustrated embodiment, the restoration material 110 enters the fluid atomization and induction fitting 125 near the top of the fluid atomization and induction fitting 127. In the illustrated embodiment, the restoration material 110 is atomized and mixed with flowing air 165 by the fluid atomization and induction fitting 125, generating atomized fluid 170. In the depicted embodiment, the atomized fluid 170 is dispersed in the exhaust pipe 155 based on the pressure drop created through the exhaust system by the strong vacuum 145 supplied by vacuum cleaner 150. In the illustrated embodiment, the shop vacuum 150 vacuum hose 215 provides the negative pressure 220 to generate the atomized fluid 170 and enable dispersion of the atomized restoration fluid 170 onto the catalytic converter substrate 205. In the depicted embodiment the atomization and induction fitting 125 includes the fluid injection tube 175 fluidly connected with the dispersing nozzle 180. In the illustrated embodiment, the restoration material 110 is ingested to the fluid atomization and induction fitting 125 through the fluid injection tube 175. In the depicted embodiment, the restoration material 110 is ingested through the fluid injection tube 175 and to the dispersing nozzle 180 discharge point within the interior of the induction fitting where it is atomized under vacuum, and dispersed through the induction fitting 125 discharge point 185 at the sensor port 120. The embodiment fluid injection tube 175 and dispersing nozzle 180 depicted in FIG. 2 illustrate an exemplary dispersing nozzle design including a substantially straight flow nozzle design. In the embodiment illustrated by FIG. 2, the exemplary fluid injection tube 175 longitudinal axis is disposed substantially parallel with the first catalytic converter aperture dimension, which is disposed substantially conformant with the catalytic converter 105 housing surface subsuming the aperture defined by the sensor port 120.

FIG. 3 depicts the design and use of an exemplary fluid dispenser and tube attachment fitting. In FIG. 3, the depicted embodiment assembly example includes configuring the fluid dispenser bottle 140 with the fluid dispenser attachment 305 adapted to dispense restoration material when the spray trigger 205 is activated. In the depicted embodiment, the fluid dispenser attachment 305 is configured to retain the tube attachment fitting adapter 310. In the illustrated embodiment, the tube attachment fitting adapter 310 is adapted to fluidly connect with the dispensing tube 130.

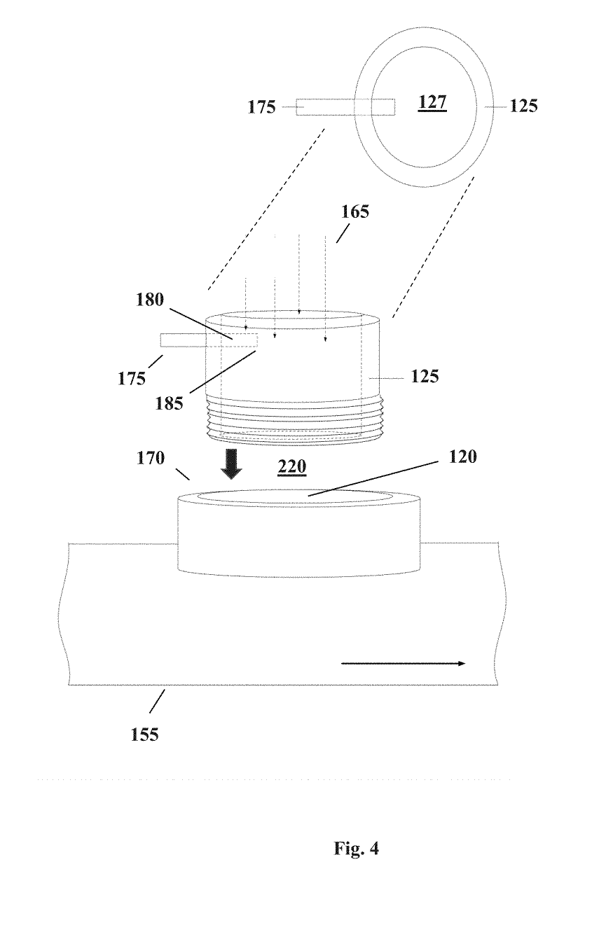

FIG. 4 is a flow diagram depicting exemplary flows of Induced Fresh Air, Negative Pressure, and Atomized Mixture Flow, due to an exemplary induction atomization fitting mating to an exemplary Oxygen Sensor Port disposed on an engine exhaust pipe. In the example depicted by FIG. 4, the exemplary fluid atomization and induction fitting 125 receives fluid through the dispensing tube 130 and atomizes the fluid, dispersing the atomized fluid 170 into the exhaust pipe 155. In the illustrated embodiment, the fluid is atomized and dispersed as a function of the negative pressure 220 created in the sensor port 120 by the flowing air 165 through the atomization and induction fitting 125.

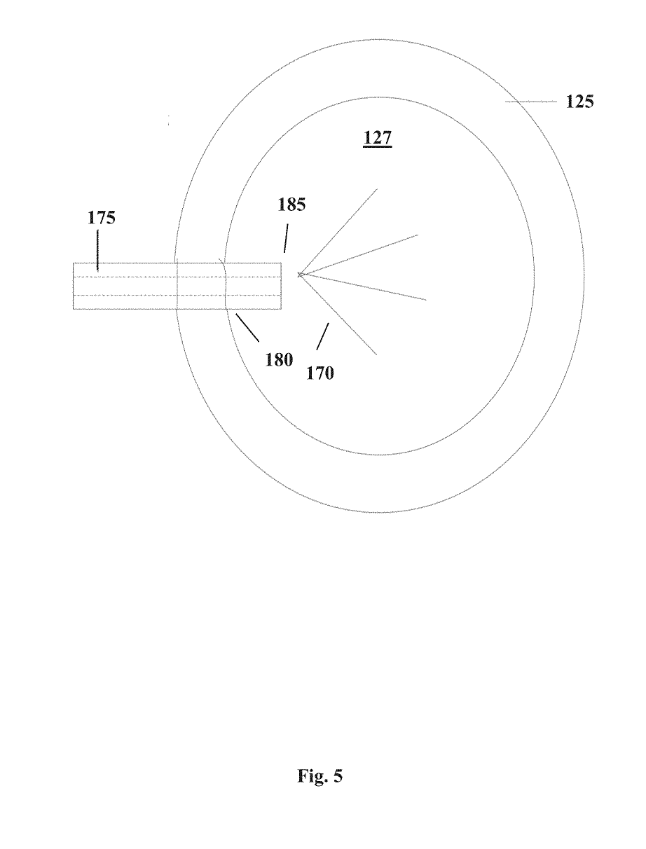

FIG. 5 depicts a top view of an exemplary fluid dispersing fitting atomizing restoration fluid. In the depicted embodiment, the exemplary fluid atomization and induction fitting 125 receives and atomizes fluid from the fluid injection tube 175, and disperses the fluid into the dispersing nozzle 180 where it atomizes at the discharge point 185.

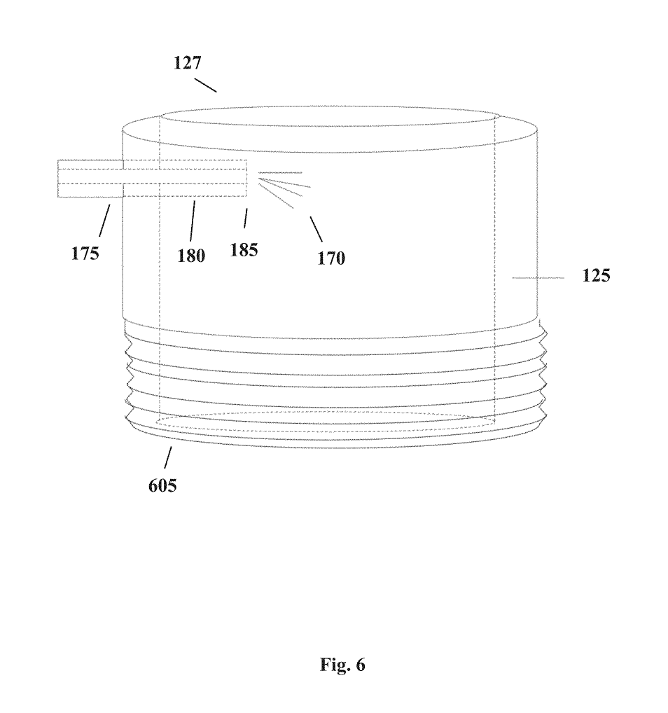

FIG. 6 depicts a side view of an exemplary fluid dispersing and atomizing fitting atomizing restoration fluid. In the illustrated embodiment, the exemplary fluid atomization and induction fitting 125 receives and atomizes fluid from the fluid injection tube 175 which results in atomized fluid 170 at the discharge point 185. In the depicted embodiment, the exemplary fluid atomization and induction fitting 125 is configured with the fitting threads 605 adapted to rotationally engage with a threaded port.

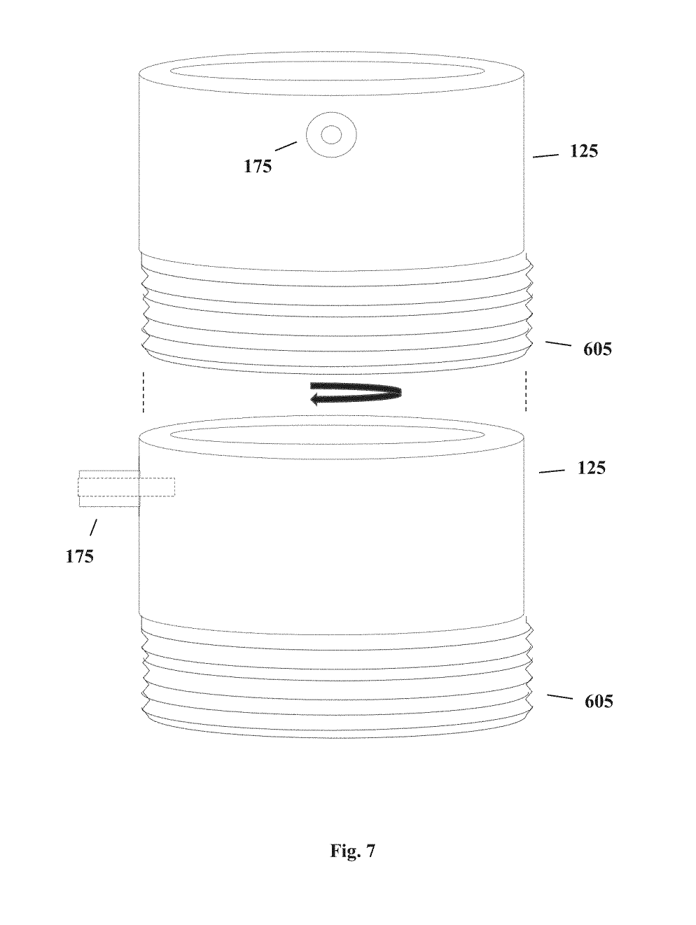

FIG. 7 depicts a side view of an exemplary fluid dispersing and atomizing fitting. In the illustrated embodiment, the exemplary fluid atomization and induction fitting 125 includes the fluid injection tube 175. In the depicted embodiment, the exemplary fluid atomization and induction fitting 125 is configured with the fitting threads 605 adapted to rotationally engage with a threaded port. In the depicted embodiment the fitting threads 605 threading pattern is configured in a right-hand thread mode. In some embodiments, the fitting threads 605 threading pattern may be configured in a left-hand thread mode. In various embodiments, the fitting threads may be omitted, such that the atomization and induction fitting 125 may slide into a sensor port or hole without the need to screw the atomization and induction fitting 125 into the sensor port or hole.

FIG. 8 depicts an operational view of an alternative embodiment catalytic converter restoration apparatus with 90-degree Low Exit Point Dispenser Nozzle restoring a catalytic converter to effective condition based on applying a vacuum to a first converter end, supplying restoration material to a second converter end to be atomized by the vacuum, and dispersing the atomized restoration material onto the catalytic converter substrate. 1n the embodiment depicted by FIG. 8, the exemplary restoration apparatus is configured to disperse the restoration material 110 onto the catalytic converter 105 substrate 205 installed in the engine 112 exhaust pipe 155. In the illustrated embodiment, the restoration material 110 is dispensed from the fluid dispenser bottle 140 as the spray trigger 210 is activated to start the restoration material 110 fluid flow. Once the restoration material 110 fluid flow starts, the fluid is pulled into the atomization and induction fitting 125. Once the fluid flow starts, the fluid may self-feed into the atomization and induction fitting 125. In an illustrative example, the fluid is atomized through the dispersing nozzle 180 as the fluid is drawn from substantially atmospheric pressure through the atomization and induction fitting 125 into an area under vacuum conditions. In the depicted embodiment, the dispensed restoration material 110 flows through the fluid injection tube 175 into the fluid atomization and induction fitting 125 installed in the sensor port 120 under substantially atmospheric pressure. In the illustrated embodiment, the restoration material 110 enters the fluid atomization and induction fitting 125 at the fluid injection tube 175 top. In the illustrated embodiment, the restoration material 110 is transferred as a liquid to the bottom of the fluid injection tube 175 located at the lower section of the dispersing nozzle 180 discharge point 185 where the material 110 is atomized as the material 110 is exposed to flowing air under vacuum conditions and mixes with flowing air 165, generating the atomized fluid 170. In the depicted embodiment, the atomized fluid 170 is dispersed in the exhaust pipe 155 based on the pressure drop created through the exhaust system by the strong vacuum 145 supplied by vacuum cleaner 150. In the illustrated embodiment, the shop vacuum 150 vacuum hose 215 provides the negative pressure 220 to generate the atomized fluid 170 and enable dispersion of the atomized restoration fluid 170 onto the catalytic converter substrate 205. In the depicted embodiment the atomization and induction fitting 125 includes the fluid injection tube 175 fluidly connected with the dispersing nozzle 180. In the illustrated embodiment, the restoration material 110 is introduced into the fluid atomization and induction fitting 125 through the fluid injection tube 175 and atomized through the discharge point 185. In the depicted embodiment, the restoration material 110 passes through the fluid injection tube 175 and is atomized at the dispersing nozzle 180 as the material 110 exits the dispersing nozzle 180 through the discharge point 185 in the exhaust pipe 155. The embodiment fluid injection tube 175 and dispersing nozzle 180 depicted in FIG. 8 illustrate an exemplary dispersing nozzle 180 design including a substantially 90-degree Low Exit Point Dispenser Nozzle design. In the embodiment illustrated by FIG. 8, the exemplary fluid injection tube 175 longitudinal axis is disposed substantially parallel with the first catalytic converter 105 aperture dimension, which is disposed substantially conformant with the catalytic converter 105 housing surface subsuming the aperture defined by the sensor port 120. In the depicted embodiment, the illustrative dispersing nozzle 180 is disposed at an angle of approximately ninety degrees with respect to the fluid injection tube 175. In the illustrated embodiment, the discharge point 185 is offset from the fluid injection tube 175 along the length of the dispersing nozzle 180 by a linear displacement determined as a function of design goals based on optimizing restoration effectiveness based on the physical arrangement of catalytic converter 105 components, as disclosed herein. Considering the discharge point 185 and dispersing nozzle 180 configuration illustrated by 2 in contrast with the particular example depicted by FIG. 8, the discharge point 185 depicted in FIG. 8 is offset from the fluid injection tube 175 along the length of the dispersing nozzle 180 by a linear displacement positioning the discharge point 185 further into the first catalytic converter 105 aperture defined by the sensor port 120 than the discharge point 185 depicted in FIG. 2.

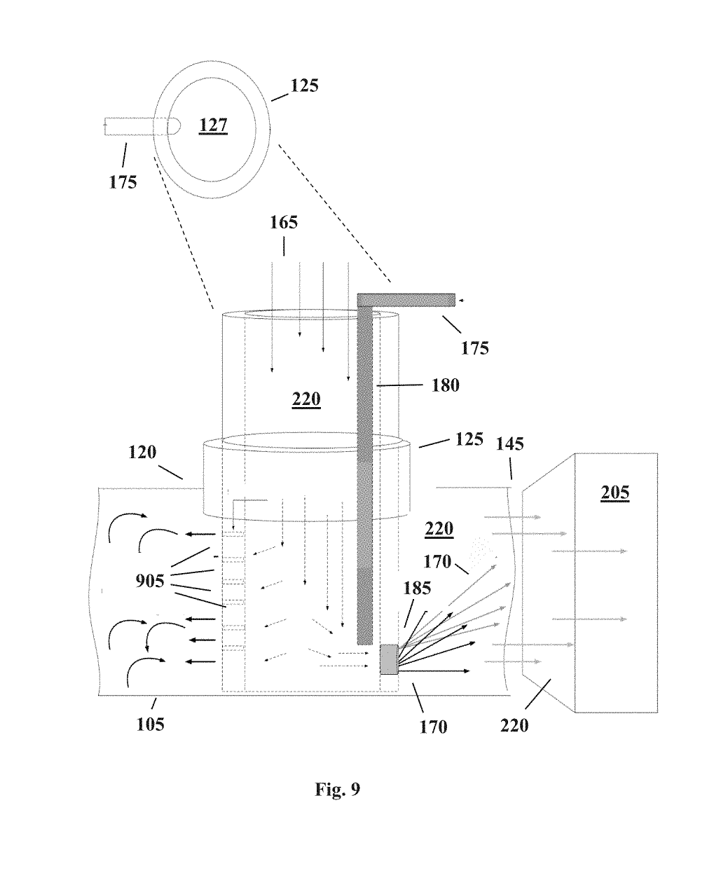

FIG. 9 depicts an exemplary 90-degree Low Exit Point induction fitting. In the depicted embodiment, fluid flows through the fluid injection tube 175 into the fluid atomization and induction fitting 125 under substantially atmospheric pressure. In the illustrated embodiment, the fluid enters the fluid atomization and induction fitting 125 at the fluid atomization and induction fitting top 127. In the illustrated embodiment, the fluid is atomized and mixed with flowing air 165 by the fluid atomization and induction fitting 125, generating atomized fluid 170. In the depicted embodiment, the atomized fluid 170 is dispersed to the catalytic converter 105 substrate 205 based on the negative pressure 220 created through the exhaust system by the strong vacuum 145, to generate the atomized fluid 170 and enable dispersion of the atomized restoration fluid 170 onto the catalytic converter 105 substrate 205. In the depicted embodiment the atomization and induction fitting 125 includes the fluid injection tube 175 fluidly connected with the dispersing nozzle 180. In the illustrated embodiment, the dispersing nozzle 180 is configured with a plurality of open air slots 905 adapted in slot area and slot number to more equally distribute the pressure relief points along the length of the dispersing nozzle 180. In various examples, the slot area or slot number may be adapted as a function of flow rate, applied vacuum pressure, restoration material density, or a desired restoration efficiency target value. In an illustrative example, the size and number of the open air slots 905 incorporated along the length of the dispersing nozzle 180 reduce backflow and allow all the material discharged from the nozzle to move in the forward direction to the catalytic converter 105 substrate 205, improving the restoration effectiveness. In the illustrated embodiment, fluid includes restoration material ingested to the fluid atomization and induction fitting 125 through the fluid injection tube 175. In the depicted embodiment, the restoration material ingested through the fluid injection tube 175 is atomized by vacuum within the Induction fitting at the dispersing nozzle 180 and dispersed through the discharge point 185 to the catalytic converter substrate. The embodiment fluid injection tube 175 and dispersing nozzle 180 depicted in FIG. 9 illustrate an exemplary dispersing nozzle 180 design including a substantially 90-degree Low Exit Point Dispenser Nozzle design. In the embodiment illustrated by FIG. 9, the exemplary fluid injection tube 175 longitudinal axis is disposed substantially parallel with the first catalytic converter 105 aperture dimension, which is disposed substantially conformant with the catalytic converter 105 housing surface subsuming the aperture defined by the sensor port 120. In the depicted embodiment, the illustrative dispersing nozzle 180 is disposed at an angle of approximately ninety degrees with respect to the fluid injection tube 175. In the illustrated embodiment, the discharge point 185 is offset from the fluid injection tube 175 along the length of the dispersing nozzle 180 by a linear displacement determined as a function of design goals based on optimizing restoration effectiveness based on the physical arrangement of catalytic converter 105 components, as disclosed herein. Considering the discharge point 185 and dispersing nozzle 180 configuration illustrated by FIG. 2 in contrast with the particular example depicted by FIG. 9, the discharge point 185 depicted in FIG. 9 is offset from the fluid injection tube 175 along the length of the dispersing nozzle 180 by a linear displacement positioning the discharge point 185 further into the first catalytic converter 105 aperture defined by the sensor port 120 than the discharge point 185 depicted in FIG. 9. In the embodiment depicted by FIG. 9, the exemplary fluid injection tube 175 is in fluid connection with the dispersing nozzle 180 in an illustrative 90-degree Low Exit Point Dispenser Nozzle configuration, and the discharge point 185 aperture central axis is disposed substantially perpendicular with the dispersing nozzle 180 longitudinal axis to aid the atomized restoration material dispersion to the catalytic converter 105 substrate 205. In the illustrated embodiment, some air is drawn upstream “backwards” which acts to equalize pressure behind the dispersing nozzle 180 and reduces the amount of fluid that otherwise draws backwards and away from the catalytic converter substrate 205.

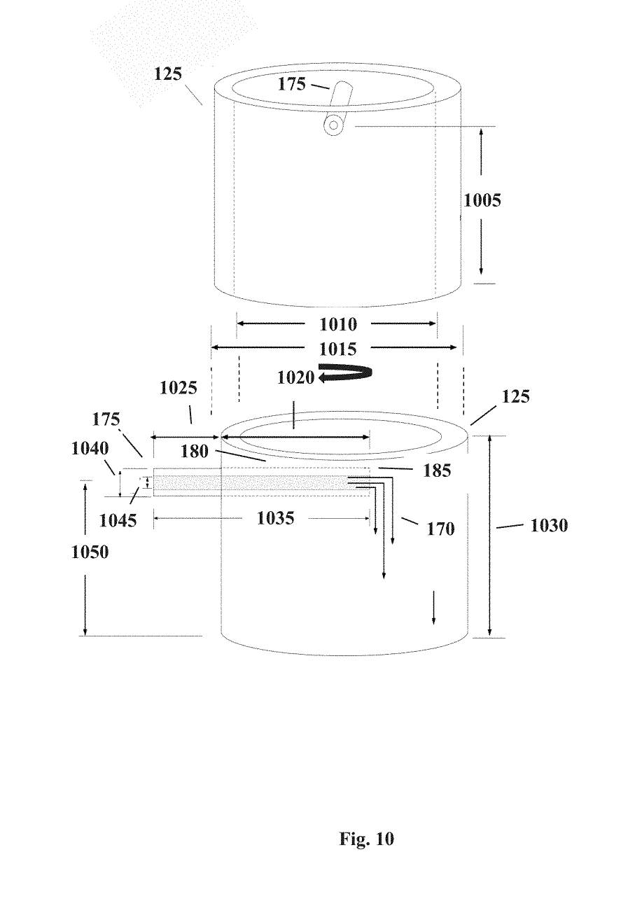

FIG. 10 depicts an exemplary Straight Flow induction fitting. In FIG. 10, the embodiment fluid atomization and induction fitting 125 includes the fluid injection tube 175 fluidly connected with the dispersing nozzle 180 configured to atomize and disperse restoration fluid onto a catalyst element. In an illustrative example, fluid is pumped into the fluid injection tube 175 which then moves out and downward onto the interior of the atomizing Induction fitting, and atomizes. The fluid spreads and mixes as it is drawn downward at great velocity by fresh air being drawn into the dispersing nozzle 180. The mixture of fresh air and the now finely divided fluid moves downstream and ultimately reaches the catalyst internal element. In various embodiments, any part of the illustrated components, including the fluid atomization and induction fitting 125, the fluid injection tube 175, and the dispersing nozzle 180, may be constructed with any effective dimensions. In the illustrated embodiment, the dimension 1005 represents an exemplary fluid atomization and induction fitting 125 displacement to the fluid injection tube 175 of 0.95 inch. In the depicted embodiment, the exemplary fluid atomization and induction fitting 125 inside diameter 1010 is 0.5 inch. In the illustrated embodiment, the exemplary fluid atomization and induction fitting 125 outside diameter 1015 is 0.625 inch. In the illustrated embodiment, the exemplary fluid atomization and induction fitting 125 dimension 1020 is 0.35 inch. In the illustrated embodiment, the exemplary fluid injection tube 175 dimension 1025 is 1.25 inch. In the depicted embodiment, the exemplary fluid atomization and induction fitting 125 height 1030 is 0.90 inch. In the depicted embodiment, the exemplary fluid injection tube 175 length 1035 is 1.6 inch. In the depicted embodiment, the exemplary fluid injection tube 175 outside diameter 1040 is 1.9 inch. In the depicted embodiment, the exemplary fluid injection tube 175 inside diameter 1045 is 1.0 inch.

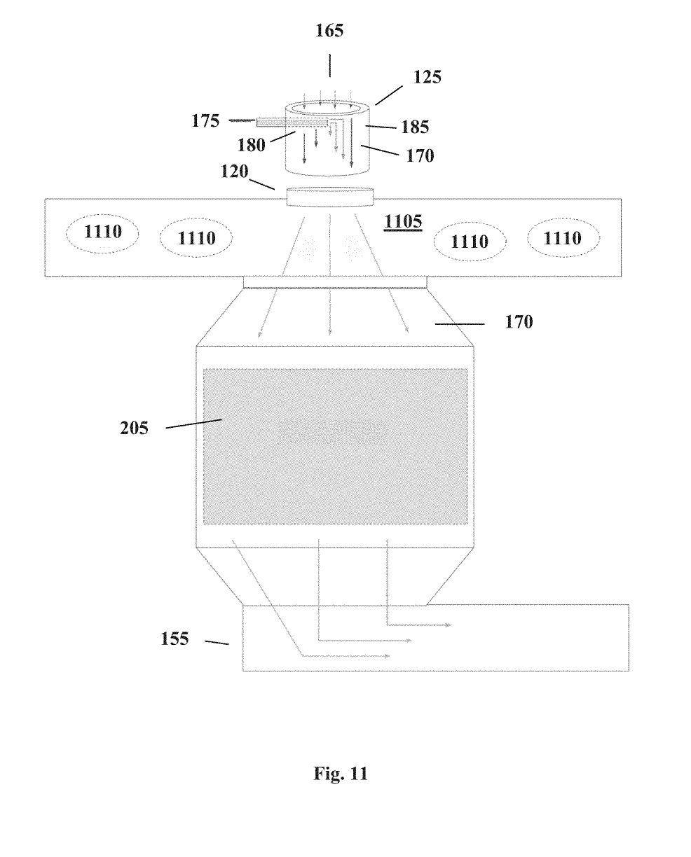

FIG. 11 depicts a schematic view of an exemplary Straight Flow induction fitting illustrating the fitting Atomizing restoration material. In the embodiment depicted by FIG. 11, fluid enters the fluid atomization and induction fitting 125 and the fluid is atomized and mixed with flowing air 165 by the fluid atomization and induction fitting 125, generating atomized fluid 170. In the depicted embodiment, the atomized fluid 170 is dispersed to the catalytic converter substrate 205 by the dispersing nozzle 180. In the depicted example, the illustrative engine exhaust manifold 1105 includes the exhaust ports 1110. In the illustrated embodiment, air flow facilitating the fluid dispersion onto the catalytic converter substrate 205 is supplied through the sensor port 120 opening in the engine exhaust manifold 1105 and created by the vacuum.

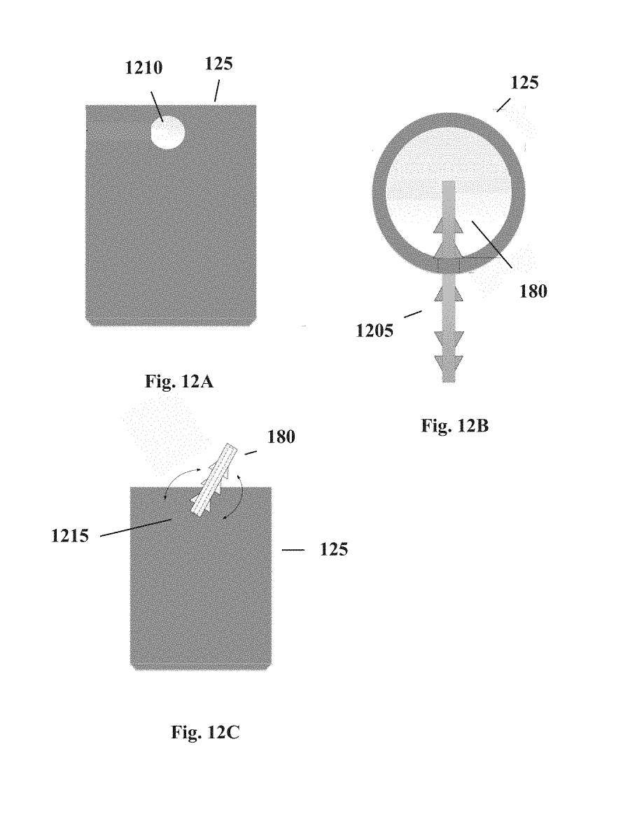

FIGS. 12A-12C depict various perspective views illustrative of exemplary Atomizing induction Fitting attachment designs. In FIG. 12A, the depicted embodiment Straight Flow Atomizing Dispensing Nozzle 1210 is configured in the illustrated fluid atomization and induction fitting 125 in a straight-flow orientation. In FIG. 12B, the illustrated embodiment Straight Flow Dispensing Nozzle 180 includes the exemplary Fluid Injector Barb 1205. In FIG. 12C, the depicted embodiment Straight Flow Dispensing Nozzle 180 includes the swivel-mounted Fluid Injector Barb 1215 pivotally movable in two dimensions to facilitate improved fluid dispersion to catalytic converter substrates in varied dispositions with respect to the fluid atomization and induction fitting 125.

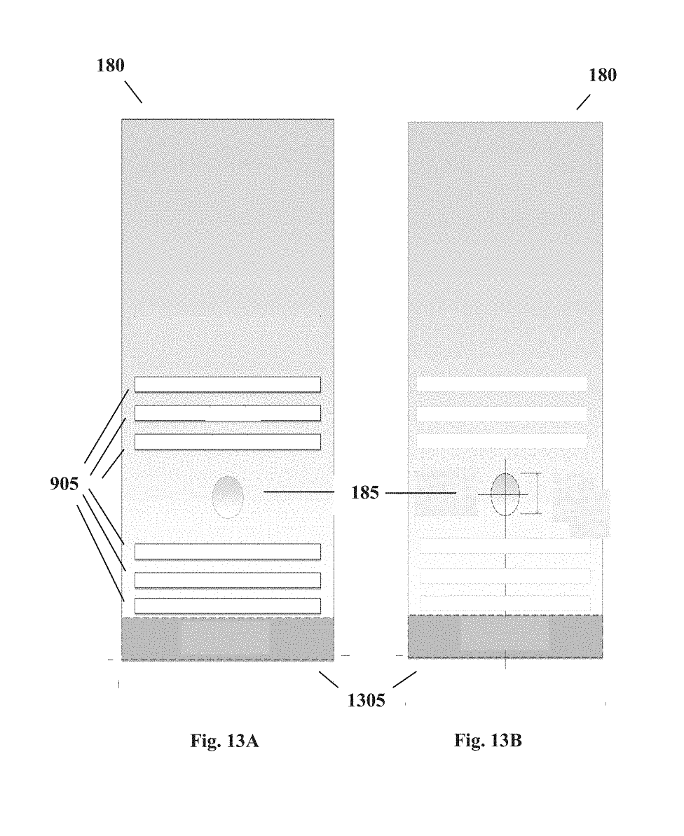

FIGS. 13A-13B depict back and front views of an exemplary 90 Degree Angle Delivery Nozzle with Mid-Level Exit Point. In FIGS. 13A and 13B, the back and front views of the exemplary 90 Degree Angle Induction Fitting Nozzle with Mid-Level Exit Point are depicted without an optional shoulder component. In FIG. 13A, the mid-level outlet Induction fitting 125 embodiment includes the discharge point 185 disposed substantially in the middle portion of the Induction fitting 125. In the depicted embodiment, the exemplary dispersing nozzle 180 back view includes the back of the discharge point 185 disposed at substantially a ninety degree angle with respect to the delivery nozzle. In the illustrated example, a plurality of pressure relief slots 905 are configured in the back of the dispersing nozzle 180 to relieve pressure and enhance dispersion efficiency and therefore restoration effectiveness. In the depicted embodiment, the plug 1305 facilitates secure engagement with a fluid connection. In FIG. 13B, in the depicted embodiment, the exemplary Induction Fitting 125 front view includes the front opening of the discharge point 185 disposed at substantially a ninety degree angle with respect to the delivery nozzle. In the illustrated example, a plurality of pressure relief slots 905 configured in the back of the Induction Fitting 125 are visible in the depicted front view.

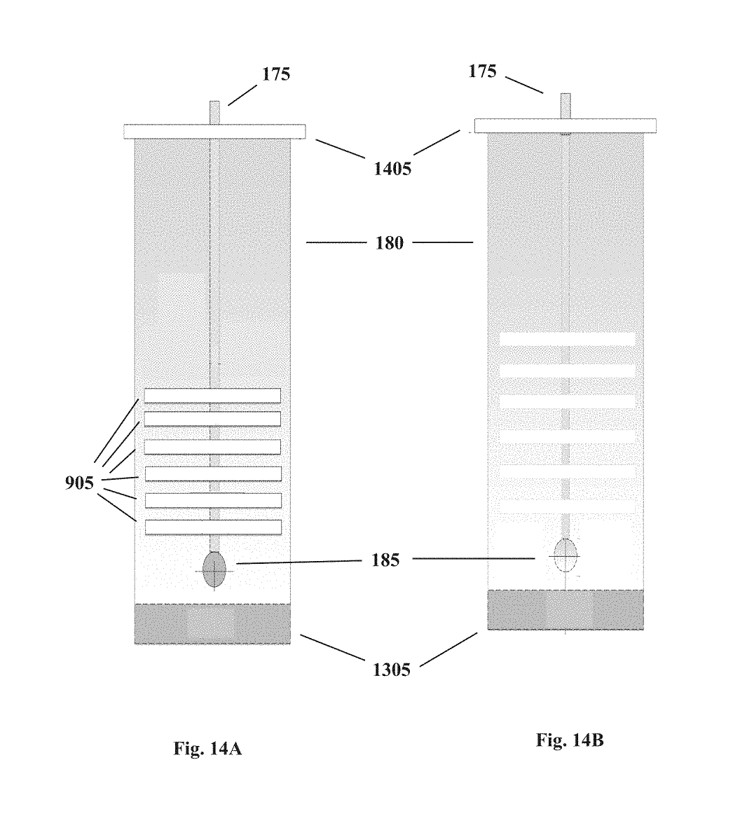

FIGS. 14A-14B depict back and front views of an exemplary 90 Degree Angle Dispensing Nozzle with Low Exit Point. In FIGS. 13A and 13B, the back and front views of the exemplary 90 Degree Angle Induction Fitting Nozzle with Low-Level Exit Point are depicted without an optional shoulder component. In FIG. 13A, the mid-level outlet Induction fitting 125 embodiment includes the discharge point 185 disposed substantially in the middle portion of the induction fitting 125. In the depicted embodiment, the exemplary dispersing nozzle 180 back view includes the back of the discharge point 185 disposed at substantially a ninety degree angle with respect to the delivery nozzle. In the illustrated example, a plurality of pressure relief slots 905 are configured in the back of the dispersing nozzle 180 to relieve pressure and enhance dispersion efficiency and therefore restoration effectiveness. In the depicted embodiment, the plug 1305 facilitates secure engagement with a fluid connection. In FIG. 13B, in the depicted embodiment, the exemplary Induction Fitting 125 front view includes the front opening of the discharge point 185 disposed at substantially a ninety degree angle with respect to the delivery nozzle. In the illustrated example, a plurality of pressure relief slots 905 are configured in the back of the dispersing nozzle 180.

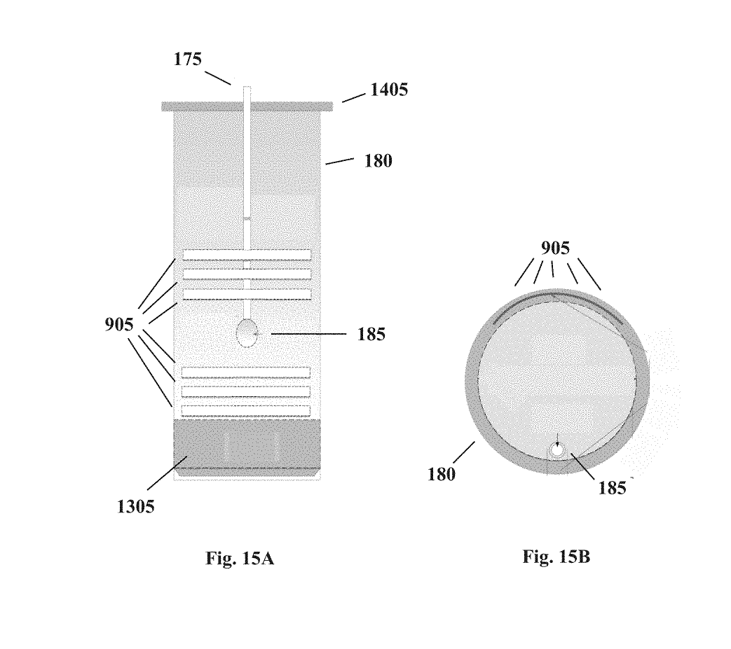

FIGS. 15A-15B depict front and top views of an exemplary 90 Degree Angle Induction Fitting with Mid-Nozzle Exit Point. In FIG. 15A, the back view of the exemplary 90 Degree Angle Fitting with Mid-Level Exit Point is depicted with the optional shoulder 1405. In this mid-level exit point dispersing nozzle 180 embodiment, the discharge point 185 is disposed substantially at the middle portion of the Induction Fitting 125. In the embodiment depicted by FIG, 15A, the exemplary Induction Fitting 125 back view includes the back of the discharge point 185 disposed at substantially a ninety degree angle with respect to the delivery nozzle. In the illustrated example, a plurality of pressure relief slots 905 are configured in the back of the dispersing nozzle 180 to relieve pressure and enhance dispersion efficiency and therefore restoration effectiveness. In the depicted embodiment, the plug 1305 facilitates secure engagement with a fluid connection. In FIG. 15B, the exemplary Induction Fitting 125 top view includes the front opening of the discharge point 185 disposed at substantially a ninety degree angle with respect to the delivery nozzle. In the illustrated example, a plurality of pressure relief slots 905 configured opposite the discharge point 185 in the back of the dispersing nozzle 180 are visible in the depicted top view.

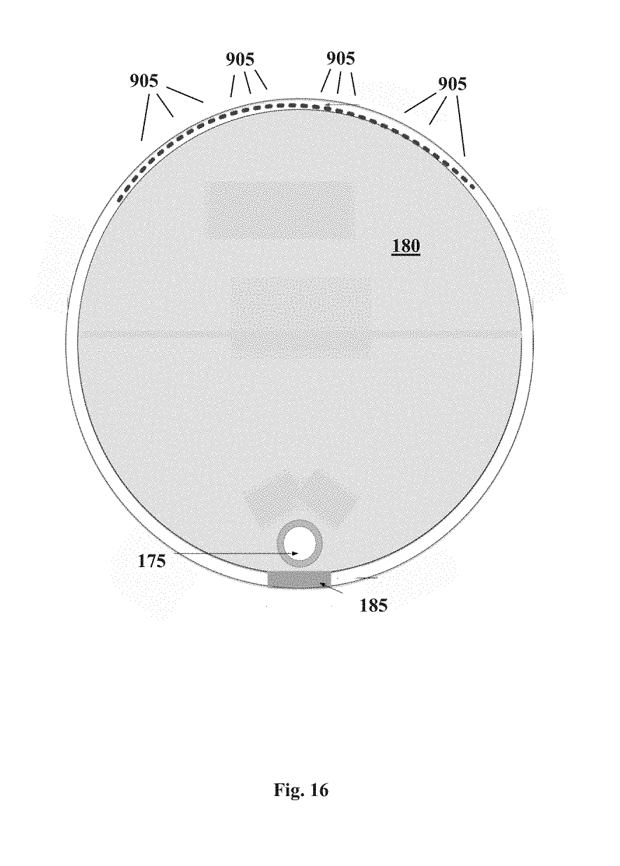

FIG. 16 depicts a top view of an exemplary 90 Degree Induction Fitting Dispenser. In the embodiment depicted by FIG. 16, the exemplary Induction Fitting 125 top view includes the front opening of the discharge point 185 disposed at substantially a ninety degree angle with respect to the fluid injection tube 175. In the illustrated example, a plurality of pressure relief slots 905 configured opposite the discharge point 185 in the back of the induction Fitting 125 are visible in the depicted top view. In the illustrated example, the air slots 905 and the discharge point 185 are one-hundred and eighty degrees apart on opposite sides of the Induction Fitting 125.

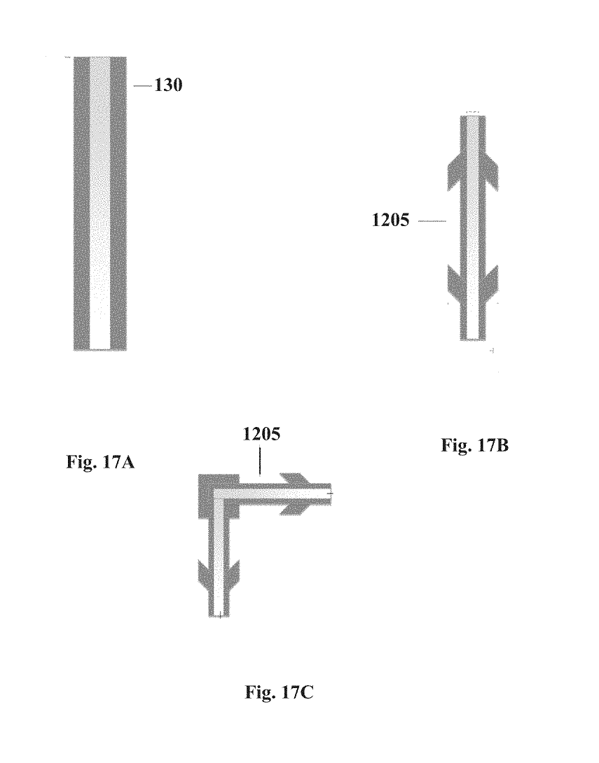

FIGS. 17A-17C depict various perspective views of exemplary Fluid Transfer Tube and Injector Barb designs. In FIG. 17A, the embodiment flexible fluid dispensing tube 130 is configured with inside and outside diameters selected to facilitate fitting snugly over an attachment barb fitting, fluid injector tube, or trigger bottle outlet. In FIG. 17B, the embodiment Fluid Injector Barb 1205 is an exemplary straight-flow design. In FIG. 17C, the embodiment Fluid Injector Barb 1205 is an exemplary ninety-degree or elbow flow implementation.

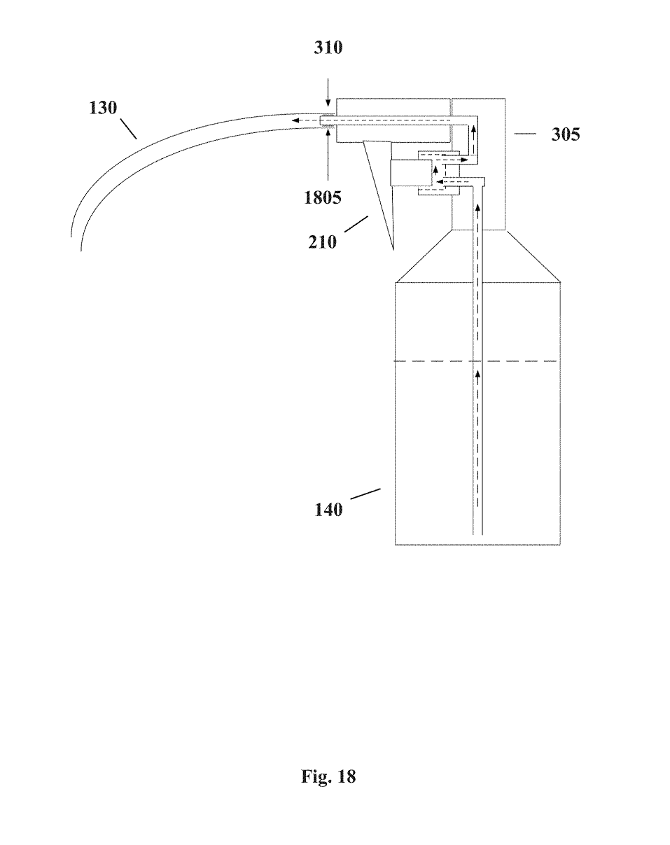

FIG. 18 depicts an exemplary Fluid Dispenser Trigger Pump and Fluid Container with a connected Fluid Transfer Tube. In the embodiment depicted by FIG. 18, the fluid transfer tube 130 is secured by the glue connection 1805 to the tube attachment fitting adapter 310. In the illustrated embodiment, the tube attachment fitting adapter 310 fluidly connects the fluid dispenser bottle 140 with the fluid dispenser attachment 305 and spray trigger 210.

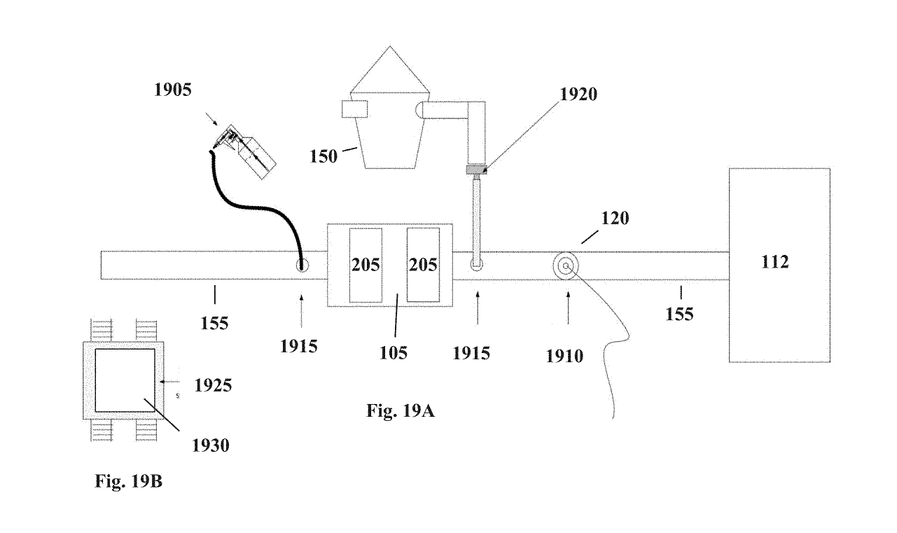

FIGS. 19A-19B depict various schematic views of an exemplary On-Vehicle Catalyst Recoating System Using Drilled Holes for Vacuum Nozzle and Induction Fitting and Multi-Direction Catalyst Coating. FIG. 19A depicts an exemplary on-vehicle catalyst recoating system using drilled holes for vacuum nozzle and dispersing nozzle multi-direction catalyst coating. In an illustrative example, this technique makes it possible to disperse coating fluids or draw vacuum from either side of the catalytic converter. In some examples, it may be more effective to coat large catalysts by dispersing fluid to both sides of the catalyst element (inlet and outlet sides, for example). In some scenarios, it may be useful to drill holes when an oxygen sensor port is far away from the catalytic converter, or when the oxygen sensor is difficult to access, or when the oxygen sensor cannot be removed. In FIG. 19A, the recoating system 1905 supplies restoration fluid through a first drilled hole 1915 in exhaust pipe 155. In the depicted embodiment, the vacuum cleaner 150 applies vacuum through hose adaptor 1920 to a second drilled hole 1915 in exhaust pipe 155. In the depicted embodiment, the oxygen sensor 1910 remains installed in the sensor port 120 while the two substrates 205 of catalytic converter 105 are recoated. In the embodiment depicted by FIG. 19B, the drilled holes may be resealed using an embodiment exhaust pipe hole patch including high temperature gasket hole patch 1925 secured by a stainless steel sheet metal gasket cover 1930.

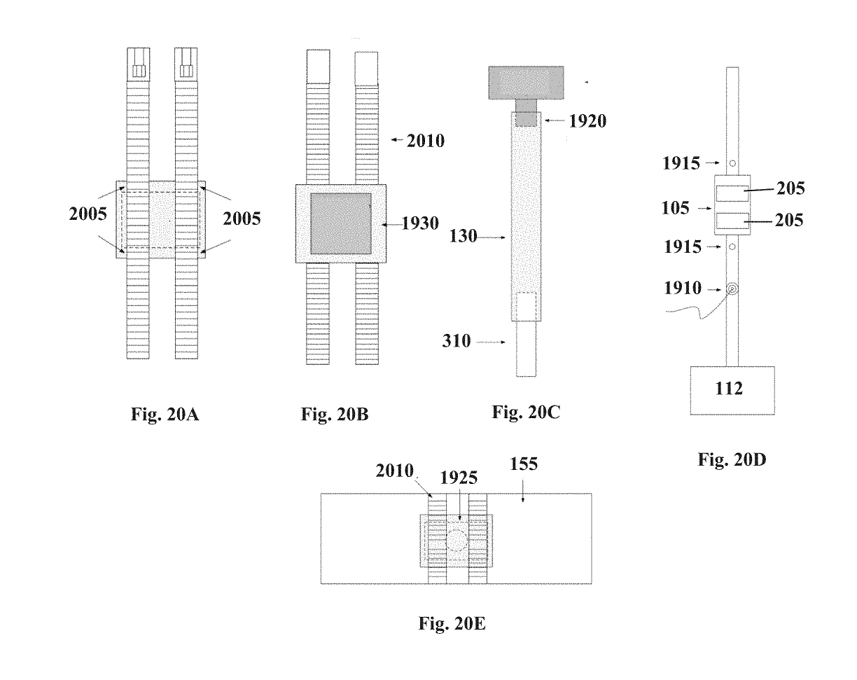

FIGS. 20A-20E depict various assembly views illustrative of an exemplary On-Vehicle Recoating System using Drilled. Holes in the Exhaust Pipe, an exemplary Universal Hole Patch, and an exemplary Vacuum Hose to Nozzle Insert Adapter Assembly. In FIG. 20A, drilled holes are patched with exemplary spot welds securing worm gear to steel patch cover 2005. In FIG. 20B, drilled holes are repaired with an exemplary exhaust pipe hole patch including a stainless steel sheet metal gasket cover 1930 secured by an embodiment worm gear style stainless steel hose clamp 2010. In FIG. 20C, an embodiment hose adaptor 1920 is connected with the tube attachment fitting adapter 310 through the fluid dispensing tube 130. In FIG. 20D, the two substrates 205 of catalytic converter 105 are recoated through drilled holes 1915 while installed with the engine 112 and while the oxygen sensor 1910 remains installed. In FIG. 20E, drilled holes in the exhaust pipe 155 are repaired with an embodiment high temperature gasket hole patch 1925 and worm gear style stainless steel hose clamp 2010.

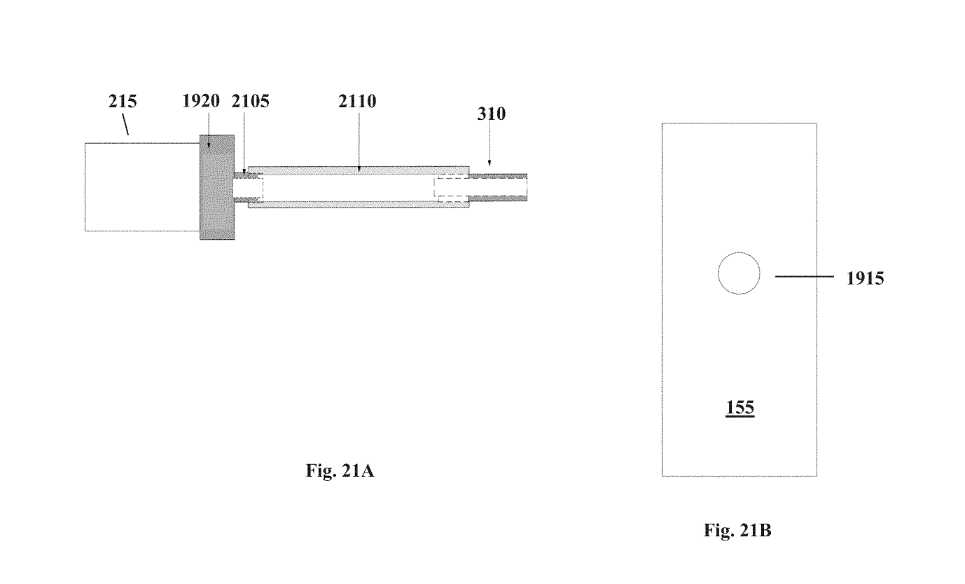

FIGS. 21A-21B depict various assembly views of an exemplary Vacuum Nozzle Adapter, Flexible Hose, and Suction Nozzle. In FIG. 21A, the embodiment restoration fluid delivery assembly includes the vacuum hose 215 and hose adaptor 1920 connected by the suction nozzle 2105 with the tube attachment fitting adapter 310 through the common flexible tube 2110. In FIG. 21B, drilled hole 1915 in exhaust pipe 155 may be connected to the tube attachment fitting adapter 310 depicted in FIG. 21A, to facilitate restoration of any catalytic converter connected with the exhaust pipe 155.

Although various embodiments have been described with reference to the Figures, other embodiments are possible. For example, some embodiments may include an embodiment catalytic converter repair or restoration kit apparatus. In various implementations, such an embodiment catalytic converter repair or restoration kit apparatus may be designed to accommodate a single use. In various implementations, an embodiment catalytic converter repair or restoration kit apparatus may employ disposable components. In some designs, an embodiment catalytic converter repair or restoration kit apparatus may employ recyclable components. In various examples, embodiment apparatus or embodiment methods may facilitate restoring functionality to an expired or non-functioning catalytic converter. In some examples, an embodiment apparatus or embodiment methods may facilitate restoring functionality to an expired or non-functioning catalytic converter which is still present and installed on the motor vehicle.

Advantage Information Regarding Nozzle Design and Purpose

Various embodiments may include nozzle designs adapted based on variation in nozzle flow angle or nozzle discharge point. Three exemplary nozzle designs are disclosed; however, an embodiment nozzle design may encompass any effective nozzle flow angle or nozzle discharge point. For example, in some embodiments, the nozzle design includes a substantially straight flow nozzle. In various embodiments, the nozzle design includes a 90° discharge Model nozzle with a mid-nozzle discharge point. In various implementations, the 90° discharge Model nozzle with a mid-nozzle discharge point may be configured with a substantially or approximately 90° discharge angle. In some designs, the 90° discharge Model nozzle with a mid-nozzle discharge point may be configured with a discharge point that is disposed substantially or approximately mid-nozzle.

In some embodiments, the nozzle design (AKA Induction Fitting design) includes a 90° discharge model nozzle with a low point discharge. In various implementations, the 90° discharge model nozzle with a low point discharge may be configured with a substantially or approximately 90° discharge angle. In some designs, the 90° discharge model nozzle with a low point discharge may be configured with a discharge point that is disposed substantially or approximately low-nozzle.

The straight flow nozzle design may be appropriate for situations where the catalytic converter element face sits directly beneath, or up to a 45-degree angle from the oxygen sensor port opening.

The 90° discharge models may be for use when the catalytic converter is at a right angle (between 45 and 90 degrees) to the oxygen sensor port opening. Testing showed that when a straight through nozzle design of the Induction Fitting 125 was used on configurations where the catalyst face and the oxygen sensor port opening were at a 90° angle to each other, poor distribution of fluid was observed. The 90° Induction fitting nozzle design provided a dramatic improvement over the straight through nozzle version, in getting the fluid from the nozzle to the face of the catalyst. As such, two different nozzle designs may be included in the restoration kit. There was a 100% improvement in the amount of material that reached the catalyst face when using the 90° discharge nozzle. The 90° discharge nozzle also has several elements that affect how it performs. These include: the location of the discharge point (hole) along the Induction fitting nozzle length (i.e., mid nozzle and at the base of the nozzle), the size of the hole where the fluid and air mixture discharge from the nozzle, and the air slots positioned 180° from the discharge point (backwards). It was found through testing that when 100% the fluid and air mixture was discharged out of the front of the nozzle into the exhaust tube and toward the catalyst, a significant amount of the fluid was swirling around the Outside circumference of the Induction Fitting Nozzle, and then moving backwards (upstream toward engine) and away from the intended downstream target catalyst. While material was being discharged from the front of the nozzle through the discharge hole, a substantial amount of material was being drawn backwards behind the nozzle in the wrong direction where it pooled in the bottom of the exhaust pipe. It was subsequently determined that because the entire exhaust system was under vacuum, and that vacuum was being released only on the front side of the nozzle, there was an imbalance of pressure surrounding the nozzle itself. The vacuum in the system was effectively being relieved preferentially at the face of the nozzle. As material and air was released from the front of the nozzle, the sides and back of the nozzle maintained a higher vacuum (lower pressure) than the front of the nozzle. It was learned that, by providing pressure relief holes or slots at the backside of the nozzle, the pressure around the nozzle circumference would be equalized. Doing this stopped the backflow and allowed all the material discharged from the nozzle to move in the forward direction. The size and number of slots incorporated on the back side of the nozzle served to equally distribute the pressure relief points along the length of the nozzle. Since the exhaust system dead heads at the engine, there isn't any path for air to flow backwards in any significant volume. During this period of local depressurization, any air that moved into the area directly behind the nozzle, immediately reversed course and flowed forward along with the air and material being discharged at the front side of the nozzle.

In addition, the holes and slots were flow calibrated such that no restoration fluid discharges backwards directly from the back of the nozzle. It was also found that by moving the position of the discharge hole at the face of the nozzle up and down along the length of the nozzle, there was no significant change in the performance of the fluid distribution on a given exhaust pipe diameter size. While the low discharge point showed some advantage compared to a midpoint discharge when fluid was being injected into a small tube, the midpoint showed itself to be a practical middle of the road design for most applications.

In various exemplary scenarios illustrative of some embodiments' usage, the pressure in the fluid injection tube (mid-Tube) (when pumping) is less than 5″ water column positive pressure. The pressure in the fluid injection tube (close to the outlet) (when pumping) is less than 1″ water column. The negative pressure (vacuum) at the fluid injection tube outlet edge (when pumping) is negative 60″ H2O column of (Vacuum). As such, the pressure differential between the fluid entering the induction fitting 125 and the vacuum conditions within the induction fitting is driving the driving force in the atomization process.

In various embodiments, Drilled Holes may be used instead of the existing O2 sensor holes. This allows vacuum and fluid dispersion from either the front or the back of the catalyst. This is important in certain situations such as large catalyst restoration, restoration to both sides of the catalytic converter when 2 different catalyst substrates are located at either end if the converter enclosure and separated by an air gap, when the O2 sensor port is inaccessible, or when upstream O2 sensor ports that are located too far away from the catalyst to effectively disperse the fluid on to the catalyst element face. The drawings also show a hole patch device. The drawings also show an adapter from a vacuum cleaner hose to a small ⅝″ “vacuum nozzle to fit into the drilled hole.

Restoration Materials Purpose and Chemical Formulations Additional Background and Detail

### BACKGROUND

1. Substrate Element: A flow-through porous honeycomb like structure, containing a large number of small elongated channels. Each small channel is a four-sided elongated cell. With all the surface area of all of the four-sided cells added together, it amounts to very large amount of contact surface area.
2. Catalyzed Substrate Element: One that has all of the surfaces within the channels coated with specialized materials. These materials include surface area improver-magnifiers, oxygen storing material, and catalytic promotion material. In the correct quantities, proportions, and under the right conditions; these materials promote Oxidation and Reduction reactions on the surface of the channels. These chemical reactions transform pollutants and clean the engine exhaust as it passes through the channels.
3. Coating Material:
   Surface Area Improver: Further increase the microscopic surface area in the substrate channels by orders of magnitude. Catalyst metals such as Platinum, Palladium, and Rhodium reside in a finely divided form at countless sites on this vast surface area. The higher the available surface area, the more catalyst material sites are available to promote the chemical reactions (catalytic conversion).
   Oxygen storage material: Adsorbes, Stores, and then Releases excess oxygen contained in the exhaust gas during varying engine operating conditions. During lean fuel mixture engine operation conditions, excess oxygen contained in the exhaust stream is adsorbed by the oxygen storage materials. During rich fuel mixture engine operation conditions, the stored oxygen is released from the oxygen storage material. It is critical for oxygen to be present at the catalyst site for certain catalyst reactions. The oxygen storage material serves to make the oxygen available when needed.
4. “Catalyst”: Precious metals and other rare materials. Automotive catalysts most often use Platinum, Palladium, and or Rhodium together, or separately as catalytic reaction promoters. These materials are finely divided to the molecular level, and impregnated on to the Surface Area Improvers, and Oxygen Storage Materials. These catalyst materials are critical to facilitating the chemical reactions required to oxidize or reduce exhaust pollutants.
5. Degraded (worn out) Catalytic Converters: The most common reason for a catalytic converter losing effectiveness is degradation of the active catalyst surface area (the coating. In particular, is loss of the Surface Area Improver, Oxygen Storage Materials, and Precious Metal Sites. The surface area can collapse, be scoured away, or be masked over by exhaust borne contaminants.
6. Restoring the Surface Area: By replacing the lost surface area, and-or enriching the existing remaining surface area with new coating materials; the poor performance of a worn out catalytic converter can be restored to a high level of performance.

Description of Replacement Materials

A water based and slightly viscous mixture of various materials. These include rare earth oxides, or compound-rare-earth-oxides, zeolites, precious metals, and or semiprecious metals in various forms.

Purpose

When these materials in the correct forms, proportions, and quantities are applied to the degraded surface area; it improves the substrate surface area and restores catalytic performance. The Beneficial Improvements include: An increase in the total active surface area; An increase in oxygen storage capacity; and, An increase in the total number of active metal catalyst sites. The Restoring Materials include: Alumina oxide; Cerium oxide; Palladium; Platinum; and, Rhodium.

#1 Formulation (Components in Percent by Weight)
60% Water
20% Alumina oxide
19% Cerium oxide
1.0% Palladium, Platinum, and Rhodium precursor solution (together or separately) (such as a nitrate or chloride solution).

#2 Formulation (Components in Percent by Weight)
60.0% Water
39.0% Alumina-cerium-oxide compound material—Ratio 60-40 (Alumina/Cerium) Ratio 60-40 (Alumina/Cerium)
1.0% Palladium, Platinum, and Rhodium precursor solution (together or separately) (such as a nitrate or chloride solution).

#3 Formulation in (Components in Percent by Weight)
60.0% Water
39.999% Alumina-cerium-oxide as a compound material impregnated with Lanthanum
Ratio: 1/0.999/.0001/(Alumina/Cerium/Lanthanum)
1.0% Palladium, Platinum, and Rhodium precursor solution (together or separately) (such as a nitrate or chloride solution).

#4 Formulation in Percent by Weight
60.0% Water
40% Alumina-cerium-oxide as a 60-40 compound material impregnated with elemental Lanthanum, and impregnated with Elemental Palladium, Platinum, and Rhodium separately or together onto the surfaces of the oxide materials.

#5. Formulation in Percent by Weight
99.000% Water
1.0% Palladium, Platinum, and Rhodium precursor solution (together or separately) (such as a nitrate or chloride solution).

Restoration Material Composition

The restoration material is a water-based slurry, comprised of multiple types of suspended precious oxide particles, rare earth oxide particles, or compound-rare-earth-oxide particles, precious metals, and or semiprecious metals, and or transition metals, individually or in combination with each other.

Data shows that surface area enrichment that is comprised of surface area improver, oxygen storage materials, and combined with precious metals in quantities of between 1.0 gram and 20 grams of precious metals per cubic foot of catalyst volume, represent the sensible limits of acceptable performance and cost.

Where 1 gram per cubic foot of catalyst volume is a minimal precious metal enrichment level and yields Minimally acceptable catalyst performance, it is the least expensive practical loading with the shortest expected durability. A disadvantage may be that such a low enrichment level may also result in shorter expected catalyst durability. Where 20 grams may be a generous enrichment level and yields a High level of acceptable performance, it is the most expensive practical loading. An advantage may be that this high loading rate may provide maximum durability.

Acceptable Performance is defined as: The vehicles onboard diagnostics system reports acceptable catalyst performance. This means the vehicle on-board computer recognizes acceptable catalyst efficiency again, and then turns off the OBD catalyst failure code. Effective, Practical, Cost Efficient, and Durable Precious Metal Loading Range: All formulations have precious metal loading in a range between 6 and 8 grams per cubic feet. This enrichment level will improve catalyst performance to the extent that a converter will meet a vehicle's computer on board diagnostics parameters, as required to turn off a Catalyst Failure Code, and to continue performing at that acceptable level for at least 25,000 miles.

While greater than 8 grams per cubic foot will further enhance catalyst performance with stronger durability, less than 8 grams incrementally decrease the performance and lower durability.

Notes About the Different Formulations

(Formulations 1, 2, 3 & 4): describe how the various oxides and metals can be blended into these various composite mixtures. Any of these different mixtures can be dispensed onto the catalyst substrate, with each one of them yielding high catalytic performance and durability characteristics. Formulations using Compound combined oxide materials are more expensive, however make it easier to prepare the formulation recipes. Formulations using individual oxide materials can be less expensive to use and offer the unlimited ability to modify the ratios; they are more time consuming to prepare the formulation recipes.

(Formulation 5): Describes a formulation using only Palladium, Platinum and Rhodium, individually or in combination, in any precursor form such as a nitrate solution or chloride solution diluted in water and dispensed directly onto a catalyst substrate without the benefit of surface area improvers or oxygen storage materials).

Tests have shown that dispersing only precious metals over old surface area that has reached its design rated useful life, will still substantially increase catalytic performance however the durability of the revitalized catalyst performance is not as favorable. The relative condition of any given worn catalyst substrate's surface area is unknown, but it will vary widely. The incremental improvement in catalyst performance and the durability with a Precious Metal Only enrichment will be inconsistent as well. Although not ideal, offering a formulation #5 type precious metal only enrichment as a (cheep-quick fix) can also be another option.

Various embodiment catalytic converter repair or restoration kit apparatus or methods may include an inexpensive single use disposable apparatus, restoration fluid, and method, designed for an average auto mechanic to restore an expired nonfunctional catalytic converter element back to working condition. In some designs, by way of this simple and easy to use application kit, critical restoration materials may be deposited onto the surface of an expired catalyst element. In some implementations, the fluid material and application with the system, restores a previously ineffective catalytic element to effective catalytic conversion activity. Sonic embodiment restoring systems may be applied to the catalytic element without removing the exhaust system or the catalytic converter from the automotive vehicle. In various designs, embodiment catalytic converter repair or restoration kit apparatus may be applied to any combustion exhaust gas system having a catalytic converter, such as stationary engine powered systems.

In some embodiment catalytic converter repair or restoration methods, the application process may be achieved through a vehicle's existing open oxygen sensor port. In various scenarios exemplary of embodiment catalytic converter repair or restoration kit apparatus or method usage, a vehicle's existing open oxygen sensor port may be located on the exhaust pipe. In some scenarios exemplary of embodiment catalytic converter repair or restoration kit apparatus or method usage, a vehicle's existing open oxygen sensor port may be situated upstream of a catalytic converter. In some embodiments, a single use kit-apparatus may include a premeasured bottle of specialized chemical materials, a squeeze trigger pump, a flexible tube, a fluid induction fitting, and a common shop vacuum.

In various designs, embodiment catalytic converter repair or restoration apparatus may facilitate dispersion of atomized liquid slurry into the oxygen sensor port under vacuum at high velocity, then into the exhaust pipe at a point upstream of the catalytic converter. In various implementations, the material is drawn in and travels down the exhaust pipe where it is deposited onto the internal catalytic element of the catalytic converter. In some embodiment catalytic converter repair or restoration scenarios, when deposition of the atomized liquid slurry material onto the internal catalytic element of the catalytic converter is complete, the oxygen sensor may be reinstalled into the port and the vehicle started. In some scenarios, the vehicle may be operated at idle for a period of time predetermined to dry the fluid slurry previously deposited onto the catalytic substrate. In a non-limiting example, the period of time required to operate the vehicle at idle to dry the fluid may be, for example, approximately 10 minutes. In some scenarios, the vehicle may then be operated on the road for approximately another 60 minutes which builds sufficient temperature in the catalyst to calcine heat treat the materials permanently. At this point in some scenarios, the converter may be fully restored and operational.

In various embodiments, a catalytic converter restoration kit apparatus, or a method using such an apparatus, may facilitate induction, atomization, transfer, and dispersion of a predetermined amount of liquid material into an open oxygen sensor port of an internal combustion engine exhaust system, with the purpose of transferring it further along the inside length of the pipe where it is ultimately deposited onto a catalytic converter substrate element located downstream of the dispersion point.

In some embodiments, a catalytic converter restoration kit apparatus, or a method using such an apparatus, may keep dispersed materials airborne within the exhaust pipe, thus allowing it to travel effectively within the exhaust pipe to its intended destination significantly farther downstream of the introduction point.

Various implementations of an embodiment catalytic converter restoration kit apparatus, or an embodiment method using such an apparatus, may be designed to apply restoration fluid, without the need to remove the converter, or the exhaust system from the vehicle, and while it is still sealed within its permanent enclosure.

In an example illustrative of exemplary scenarios of usage, an embodiment catalytic converter restoration kit apparatus, or an embodiment method using such an apparatus, may not require an external heat source in order to calcine/heat treat the deposited fluid. In such scenarios, a vehicle engine's hot exhaust performs this task while operating under normal engine operating conditions.

In some examples, embodiment catalytic converter restoration kit apparatus, or an embodiment method using such an apparatus, may be applied by anyone capable of removing the oxygen sensor from the automobile's exhaust system.

In various exemplary scenarios of usage, some embodiment catalytic converter restoration kit apparatus, or an embodiment method using such an apparatus, may be effective to restore a catalytic converter without a need for elaborate laboratory or industrial equipment, facilities or specialized personnel.

In some examples, embodiment catalytic converter restoration kit apparatus, or an embodiment method using such an apparatus, may provide consumers with access to practical and affordable catalytic converter restoration, which may extraordinarily reduce the cost currently associated with replacing a catalytic converter. This advantage may provide an affordable alternative to defeat and cheat devices to motorists in a financially challenged situation

Various embodiments may address US-EPA requirements to replace a catalytic converter when they fail or simply wear out. Some implementations may provide a more economical alternative to catalytic converter replacement which may reduce the financial burden on motorists and improve the quality of the natural environment.

In an illustrative example, some embodiments may provide an affordable (100-200 dollars) option to restore functionality of a non-performing converter substrate element. Various embodiments may enable an average auto mechanic or mechanically inclined individual to restore or recondition a catalytic converter, without the need for any specialized facilities or equipment, and without the need to uninstall or remove the catalytic converter from the vehicle or engine.

Various embodiments of the invention in accordance with the present disclosure may include a disposable apparatus, fluid, and restoration process, that inexpensively restores full functionality to an otherwise deteriorated, degraded, spent or non-functional “Catalytic Convener” “Substrate Element”. In some scenarios exemplary of usage of some embodiments, employing such apparatus and process disclosed, may restore and activate an otherwise diminished or ineffective catalytic substrate element that has reached the end of its useful life, or where the conversion efficiency has generally fallen below desirable performance levels. In some examples, application of some embodiment systems may eliminate the need to completely replace an otherwise intact converter system. In an illustrative example, this inexpensive alternative also eliminates the need to improperly manipulate the emissions control system or employ dummy devices. In various scenarios exemplary of prior art usage, there is nothing commercially available in the public domain that will restore or re-activate a poorly performing or inactive catalytic converter catalyst element. Consumers purchase approximately 3 million replacement catalytic converters each year bearing an average range of installed prices of between $800.00 and $1,600.00 each. This amounts to a national cost to consumers of between 2.4 and 4.8 billion dollars. Various embodiments of the present invention may reduce that cost to between $600 million and 1.3 billion dollars.

In various implementations, a restoring technique in accordance with embodiments of the present invention may offer an alternative to replacement. Such an alternative may substantially reduce consumer cost meeting their vehicle emissions repair costs. In some examples, exemplary usage of a restorative process in accordance with embodiments of the present invention may be performed by a home mechanic or trained professional technician while a catalytic converter remains on the vehicle, in less than 30 minutes time.

In various scenarios exemplary of prior art usage, if a catalyst fails, the only way to bring the exhaust emissions back down to required levels may be to remove and replace the poorly functioning catalytic converter with a new or fully functioning replacement. In an example illustrative of various prior art approaches, there may be no commercially available device or means disclosed that can restore a poorly functioning catalytic converter high level of functionally, while still installed to an exhaust system.

Some implementations of embodiments of the present invention may include: a disposable 12 fluid ounce bottle containing a specialized catalytic material formulation; a squeeze trigger foam pump; a flexible ¼″ tube˜40″ long; a ⅝″″ diameter liquid atomization & induction fitting/tube (between 1″ & 3″ long, ⅝″ diameter tube open at one or both ends, with provisions to introduce a liquid to its center; and, a Shop Vacuum.

in various implementations, an embodiment fluid injection tube may be fixed in place onto the interior wall of a dispersing nozzle (for example, on the 90% discharge nozzle style). In an illustrative example, the fluid outlet point of the fluid injection tube is an engineered location for the purpose of releasing material precisely just above and flush with the edge of the hole located on the side of the dispersing nozzle. Such a fluid outlet point design creates an environment which takes advantage of venturi effect which assists in drawing fluid from the fluid injection tube, and magnifies the atomizing effects of the existing pressure differential at that location.

In the present disclosure, the atomization and induction fitting 125 may be referred to as an induction fitting, or an induction assist fitting. In the present disclosure, the dispersing nozzle 180 may be referred to as a dispensing nozzle.

In the Summary above and in this Detailed Description, and the Claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used to the extent possible in combination with and/or in the context of other particular aspects and embodiments of the invention, and in the invention generally.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of phrases such as: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In various embodiments, elements described herein as coupled or connected may have an effectual relationship realizable by a direct connection or indirectly with one or more other intervening elements.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an embodiment “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

In the specification and claims, “about” or “approximately” means within twenty percent (20%) of the numerical amount cited. For example, if a percent by weight is disclosed as approximate, the disclosed percent by weight may be within twenty percent (20%) of the numerical percent by weight cited. In an illustrative example, if a percent by weight is disclosed as approximately 10%, the disclosed percent by weight may be not less than 8% and not more than 12%.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as may be described herein-above may be used. Many suitable materials are known and available and can be selected and mixed depending on desired strength and flexibility, preferred manufacturing method and particular use, as will be apparent to a person of ordinary skill in the art.

Any element in a claim herein that does not explicitly state “means for” performing a specified function, or “step for” performing a specific function, is not to be interpreted as a “means” or “step” clause as specified in 35 U.S.C, § 112(f). Specifically, any use of “step of” in the claims herein is not intended to invoke the provisions of 35 U.S.C. § 112(f).

The embodiments disclosed hereinabove may be summarized as follows.

### Embodiment 1

An apparatus, comprising a catalytic converter restoration kit.

### Embodiment 2

An apparatus, comprising a catalytic converter restoration kit useful to restore a catalytic converter without uninstalling the catalytic converter from a vehicle.

### Embodiment 3

A process, comprising a method to apply chemicals known to restore function to a poorly functioning catalytic converter.

### Embodiment 4

A method to restore a catalytic converter to effective condition, comprising: applying a vacuum to a first converter end; supplying restoration material to a second converter end to be atomized by the vacuum; and, dispersing the atomized restoration material onto the catalytic converter substrate.

### Embodiment 5

A process, comprising a method to restore a catalytic converter without uninstalling the catalytic converter from a vehicle.

### Embodiment 6

A composition of matter, comprising: a catalytic converter restoration material mixture, comprising at least two materials present in the mixture in proportion to the at least two materials percent by weight in the mixture predetermined as a function of at least one of: restored catalytic converter durability; and, catalytic converter restoration cost.

### Embodiment 7

The invention embodiments as disclosed.

### Embodiment 8

An apparatus, comprising: a Chemical coating enrichment system configured to restore catalytic converter performance based on atomizing and dispersing catalyst restoration material onto the catalytic converter substrate as the restoration material is ingested into a first catalytic converter aperture when a pressure difference is created between the first catalytic converter aperture and a second catalytic converter aperture, comprising: an atomization and induction fitting, comprising: a fluid input; and, a fluid output fluidly connected to the fluid input, wherein the fluid output is configured to fluidly connect to the first catalytic converter aperture; and, a reservoir, adapted to dispense restoration material through a reservoir aperture configured to fluidly connect to the atomization and induction fitting fluid input, when restoration material is retained by the reservoir; and, a vacuum source, configured to fluidly connect to the second catalytic converter aperture to create a pressure difference between the first catalytic converter aperture and the second catalytic converter aperture, when the vacuum source is activated.

### Embodiment 9

The apparatus of Embodiment 8, wherein the first catalytic converter aperture further comprises an open sensor port disposed in the catalytic converter.

### Embodiment 10

The apparatus of Embodiment 9, wherein the sensor port is an oxygen sensor port.

### Embodiment 11

The apparatus of Embodiment 8, wherein the atomization and induction fitting is removably installable into an open sensor port disposed in the catalytic converter.

### Embodiment 12

The apparatus of Embodiment 8, wherein the atomization and induction fitting fluid input further comprises a fluid injection tube configured to inject into the first catalytic converter aperture restoration material ingested from the reservoir.

### Embodiment 13

The apparatus of Embodiment 8, wherein the atomization and induction fitting further comprises: a fluid injection tube disposed substantially parallel with the first catalytic converter aperture dimension disposed substantially conformant with the catalytic converter housing surface subsuming the aperture, and wherein the fluid injection tube is configured to inject into the first catalytic converter aperture restoration material dispensed from a connected reservoir; and, a dispersing nozzle configured to atomize restoration material dispensed from the reservoir.

### Embodiment 14

The apparatus of Embodiment 13, wherein the dispersing nozzle is disposed at an angle of between approximately zero and approximately ninety degrees with respect to the fluid injection tube.

### Embodiment 15

The apparatus of Embodiment 13, wherein the dispersing nozzle is disposed at an angle of approximately ninety degrees with respect to the fluid injection tube.

### Embodiment 16

The apparatus of Embodiment 13, wherein the dispersing nozzle is pivotally secured with a swivel configured to permit the dispersing nozzle to move in at least two dimensions with respect to the fluid injection tube.

### Embodiment 17

The apparatus of Embodiment 13, wherein the dispersing nozzle further includes a discharge point offset along the length of the nozzle by a linear displacement of one-half inch or less.

### Embodiment 18

The apparatus of Embodiment 13, wherein the dispersing nozzle further includes a discharge point offset along the length of the nozzle by a linear displacement of at least one-half inch but no more than one inch.

### Embodiment 19

The apparatus of Embodiment 13, wherein the dispersing nozzle further includes a discharge point offset along the length of the nozzle by a linear displacement of at least one inch.

### Embodiment 20

The apparatus of Embodiment 13, wherein the dispersing nozzle further includes at least one pressure relief slot disposed in the nozzle surface.

### Embodiment 21

The apparatus of Embodiment 20, wherein the pressure relief slot quantity and size are determined as a function of pressure.

### Embodiment 22

The apparatus of Embodiment 8, wherein the atomization and induction fitting fluid output further comprises a dispersing nozzle configured to atomize restoration material dispensed from a connected reservoir when a connected vacuum source is activated.

### Embodiment 23

The apparatus of Embodiment 8, wherein the atomization and induction fitting fluid output further comprises a dispersing nozzle configured to disperse onto a catalytic converter substrate restoration material dispensed from the reservoir into the first catalytic converter aperture when a connected vacuum source is activated.

### Embodiment 24

The apparatus of Embodiment 8, wherein the restoration material further comprises a water-based slurry.

### Embodiment 25

The apparatus of Embodiment 8, wherein the restoration material further comprises a rare earth oxide selected from the group Alumina, Ceria, Zirconia, Lanthanum, yttrium, and Titanium.

### Embodiment 26

The apparatus of Embodiment 8, wherein the restoration material further comprises a precious metal selected from the group Palladium, Platinum, Rhodium, and ruthenium.

### Embodiment 27

The apparatus of Embodiment 8, wherein the restoration material further comprises a material selected from the group barium, and vanadium.

### Embodiment 28

The apparatus of Embodiment 8, wherein the restoration material further comprises in approximate percent by weight: 60.0% Water, 39.0% Alumina-cerium-oxide compound material in an approximate Ratio of 60-40 (Alumina/Cerium), and the balance being Palladium, and or Platinum, and or Rhodium precursor solution having between 5% and 30% metals contained within, whether individual or combined metals.

### Embodiment 29

The apparatus of Embodiment 8, wherein the restoration material further comprises in approximate percent by weight: 60.0% Water, 39.00% Alumina-cerium-oxide as a compound material impregnated with Lanthanum in an approximate Ratio of 1/0.999/.0001/ (Alumina/Cerium/Lanthanum), and 1.0% Palladium, and or Platinum, and or Rhodium precursor solution having between 5% and 30% metals contained within, whether individual or combined metals.

### Embodiment 30

The apparatus of Embodiment 8, wherein the restoration material further comprises in approximate percent by weight: 60.0% Water, and 40% being Precious Metals, Alumina-cerium-oxide as an approximately 60-40 compound material impregnated with elemental Lanthanum, and impregnated with Elemental Palladium, Platinum, and Rhodium separately or together onto the surface of the oxide materials at precious metals to oxides ratios of (between 0.0005 and 0.0020) to 1.0 by weight.

### Embodiment 31

The apparatus of Embodiment 8, wherein the restoration material further comprises in approximate percent by weight: 89.0 to 99.0% Water, Palladium, and or Platinum, and or Rhodium precursor solution having between 1% and 10% metals contained within, whether individual or combined metals.

### Embodiment 32

An apparatus, comprising: a refurbishing system configured to restore catalytic converter performance based on atomizing and dispersing restoration material onto the catalytic converter substrate as the restoration material is ingested into a first catalytic converter aperture, when a pressure difference is created between the first catalytic converter aperture and a second catalytic converter aperture, comprising: an atomization and induction fitting, comprising: a fluid input, comprising: a fluid injection tube configured to inject restoration material into the first catalytic converter aperture; and, a fluid output configured to fluidly connect to the first catalytic converter aperture through an open oxygen sensor port, the fluid output comprising: a dispersing nozzle fluidly connected to the fluid input, wherein the dispersing nozzle is disposed at an angle of between approximately zero and approximately ninety degrees with respect to the fluid injection tube, and wherein the dispersing nozzle further includes at least one pressure relief aperture disposed in the nozzle surface; and, a discharge point offset by a linear displacement along the length of the nozzle from the fluid input; and, a reservoir retaining restoration fluid, wherein the reservoir is adapted to dispense restoration material through a reservoir aperture configured to fluidly connect to the atomization and induction fitting fluid input; and, a vacuum source, configured to fluidly connect to the second catalytic converter aperture to create a pressure difference between the first catalytic converter aperture and the second catalytic converter aperture, when the vacuum source is activated.

### Embodiment 33

The apparatus of Embodiment 32, wherein the fluid injection tube is disposed substantially parallel with the first catalytic converter aperture dimension that is disposed substantially conformant with the catalytic converter housing surface subsuming the aperture, and wherein the fluid injection tube is configured to inject into the first catalytic converter aperture restoration material dispensed from a connected reservoir.

### Embodiment 34

The apparatus of Embodiment 32, wherein the dispersing nozzle is configured to atomize restoration material dispensed from the reservoir.

### Embodiment 35

The apparatus of Embodiment 32, wherein the discharge point is offset along the length of the nozzle by a linear displacement of not more than one-half inch.

### Embodiment 36

The apparatus of Embodiment 32, wherein the discharge point is offset along the length of the nozzle by a linear displacement of at least one-half inch but not more than one inch.

### Embodiment 37

The apparatus of Embodiment 32, wherein the discharge point is offset along the length of the nozzle by a linear displacement of at least one inch.

### Embodiment 38

The apparatus of Embodiment 32, wherein the at least one pressure relief aperture disposed in the nozzle surface substantially defines a parallelogram.

### Embodiment 39

The apparatus of Embodiment 32, wherein the at least one pressure relief aperture disposed in the nozzle surface substantially defines a circle.

### Embodiment 40

The apparatus of Embodiment 32, wherein the at least one pressure relief aperture disposed in the nozzle surface substantially defines an ellipse.

### Embodiment 41

The apparatus of Embodiment 32, wherein the at least one pressure relief aperture disposed in the nozzle surface substantially defines a triangle.

### Embodiment 42

The apparatus of Embodiment 32, wherein the at least one pressure relief aperture disposed in the nozzle surface substantially defines a square.

### Embodiment 43

The apparatus of Embodiment 32, wherein the at least one pressure relief aperture disposed in the nozzle surface substantially defines a rectangle.

### Embodiment 44

The apparatus of Embodiment 32, wherein the at least one pressure relief aperture disposed in the nozzle surface is a substantially rectangular slot.

### Embodiment 45

The apparatus of Embodiment 32, wherein the at least one pressure relief aperture disposed in the nozzle surface is disposed on the nozzle side opposite from the discharge point.

### Embodiment 46

The apparatus of Embodiment 32, wherein the at least one pressure relief aperture disposed in the nozzle surface is disposed on the nozzle backside.

### Embodiment 47

The apparatus of Embodiment 32, wherein the at least one pressure relief aperture disposed in the nozzle surface is disposed approximately one-hundred-eighty degrees from the discharge point.

### Embodiment 48

The apparatus of Embodiment 32, wherein the at least one pressure relief aperture disposed in the nozzle surface includes a plurality of pressure relief apertures.

### Embodiment 49

The apparatus of Embodiment 32, wherein the at least one pressure relief aperture further comprises a plurality of pressure relief apertures, and wherein the pressure relief aperture quantity is determined as a function of pressure.

### Embodiment 50

The apparatus of Embodiment 32, wherein the at least one pressure relief aperture further comprises a plurality of pressure relief apertures, and wherein the pressure relief aperture quantity is determined as a function of negative pressure.

### Embodiment 51

The apparatus of Embodiment 32, wherein the at least one pressure relief aperture further comprises a plurality of pressure relief apertures, and wherein the pressure relief aperture quantity is determined as a function of vacuum pressure.

### Embodiment 52

The apparatus of Embodiment 32, wherein the at least one pressure relief aperture further comprises a plurality of pressure relief apertures, and wherein the pressure relief aperture quantity is determined as a function of pressure measured in the atomization and induction fitting.

### Embodiment 53

The apparatus of Embodiment 32, wherein the at least one pressure relief aperture further comprises a plurality of pressure relief apertures, and wherein the pressure relief aperture quantity is determined as a function of restoration material flow rate.

### Embodiment 54

The apparatus of Embodiment 32, wherein the at least one pressure relief aperture further comprises a plurality of pressure relief apertures, and wherein the pressure relief aperture quantity is determined as a function of restoration material remaining.

### Embodiment 55

The apparatus of Embodiment 32, wherein the at least one pressure relief aperture size is determined as a function of restoration material flow rate.

### Embodiment 56

The apparatus of Embodiment 32, wherein the at least one pressure relief aperture size is determined as a function of pressure.

### Embodiment 57

The apparatus of Embodiment 32, wherein at least one of the at least one pressure relief aperture is configured to engage with a user-installable plug adapted to block air flow through the aperture.

### Embodiment 58

The apparatus of Embodiment 32, wherein the dispersing nozzle is pivotally secured with a swivel configured to permit the dispersing nozzle to move in at least two dimensions with respect to the fluid injection tube.

### Embodiment 59

The apparatus of Embodiment 32, wherein the atomization and induction fitting fluid output further comprises a dispersing nozzle configured to atomize restoration material dispensed from a connected reservoir when a connected vacuum source is activated.

### Embodiment 60

The apparatus of Embodiment 32, wherein the atomization and induction fitting fluid output further comprises a dispersing nozzle configured to disperse onto a catalytic converter substrate restoration material dispensed from the reservoir into the first catalytic converter aperture when a connected vacuum source is activated.

### Embodiment 61

The apparatus of Embodiment 32, wherein the restoration material further comprises a rare earth oxide selected from the group Alumina, Ceria, Zirconia, Lanthanum, yttrium, and Titanium.

### Embodiment 62

The apparatus of Embodiment 32, wherein the restoration material further comprises a precious metal selected from the group Palladium, Platinum, Rhodium, and ruthenium.

### Embodiment 63

The apparatus of Embodiment 32, wherein the restoration material further comprises a material selected from the group barium, and vanadium.

### Embodiment 64

The apparatus of Embodiment 32, wherein the apparatus further comprises: a catalytic converter having a first aperture and a second aperture; wherein the reservoir aperture is fluidly connected to the atomization and induction fitting fluid input; wherein the atomization and induction fitting fluid output is fluidly connected to the catalytic converter first aperture; and, wherein the catalytic converter second aperture is fluidly connected to the vacuum source.

### Embodiment 65

A process, comprising: a method to restore catalytic converter performance based on atomizing and dispersing restoration material under vacuum onto the catalytic converter substrate as the restoration material is ingested into a first catalytic converter aperture, when a pressure difference is created between the restoration nozzle discharge point located at the first catalytic converter aperture and a second catalytic converter aperture, comprising: supplying restoration material to a first catalytic converter aperture at substantially atmospheric pressure; applying a vacuum to a second catalytic converter aperture to atomize the restoration material; and, dispersing the atomized restoration material onto the catalytic converter substrate.

### Embodiment 66

The process of Embodiment 65, wherein applying a vacuum further comprises connecting a shop vacuum cleaner or any vacuum source capable of drawing 100 cfm at 65″ of water to the second catalytic converter aperture.

### Embodiment 67

The process of Embodiment 65, wherein supplying restoration material to the first catalytic converter aperture further comprises supplying the restoration material through an open catalytic converter oxygen sensor port.

### Embodiment 68

The process of Embodiment 65, wherein the restoration material further comprises a precious metal composition.

### Embodiment 69

The process of Embodiment 68, wherein the precious metal composition is determined as functions of catalytic converter restoration cost and restored catalytic converter durability.

### Embodiment 70

The process of Embodiment 65, wherein the catalytic converter performance is restored without removing the catalytic converter from the vehicle in which the catalytic converter is installed.

### Embodiment 71

The process of Embodiment 65, wherein the process further comprises supplying restoration material into the second catalytic converter aperture and applying the vacuum to the first catalytic converter aperture.

### Embodiment 72

The process of Embodiment 65, wherein the process further comprises running the vehicle engine for a time effective to activate the restoration material dispersed onto the catalytic converter substrate.

### Embodiment 73

A composition of matter, comprising: a restoration material including in approximate percent by weight: 60% Water, 20% Alumina oxide, 19% Cerium oxide, and the balance being Palladium, and or Platinum and or Rhodium precursor solution having between 5.0 and 30.0% metals contained, whether individual or combined metals.

### Embodiment 74

A composition of matter, comprising: a restoration material including in approximate percent by weight: 60.0% Water, 39.0% Alumina-cerium-oxide compound material in an approximate Ratio of 60-40% (Alumina/Cerium), and the balance Palladium and or Platinum and or Rhodium precursor solutions having between 5.0 and 30.0% metals contained within whether individual or combined.

### Embodiment 75

A composition of matter, comprising: a restoration material including in approximate percent by weight: 60.0% Water, 39.0% Alumina-cerium-oxide as a compound material impregnated with Lanthanum in an approximate Ratio of 1/0.999/.0001/ (Alumina/Cerium/Lanthanum), and the balance Palladium and or Platinum and or Rhodium precursor solutions having between 5.0 and 30.0% metals contained within whether individual or combined.

### Embodiment 76

A composition of matter, comprising: a restoration material including in approximate percent by weight: 60.0% Water, and 40% Precious Metals, Alumina-cerium-oxide as an approximately 60-40 compound material impregnated with elemental Lanthanum, and impregnated with Elemental Palladium and or, Platinum and or Rhodium at precious metals to oxides ratios (between 0.0005 and 00.20) to 1.0 by weight.

### Embodiment 77

A composition of matter, comprising: a restoration material including in approximate percent by weight: 89.0 to 99.000% Water, and Palladium and or, Platinum and or Rhodium precursor solutions having between 1.0 and 11% metals contained within either combined or individual.

### Embodiment 78

An article of manufacture, comprising: a dispersing nozzle configured to aid in the atomization of restoration material dispensed from a restoration material reservoir fluidly connected with the dispensing nozzle.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. An apparatus, comprising:
a refurbishing system configured to restore catalytic converter performance based on atomizing and dispersing restoration material onto the catalytic converter substrate as the restoration material is ingested into a first catalytic converter aperture when a pressure difference is created between the first catalytic converter aperture and a second catalytic converter aperture using vacuum, comprising:
an atomization and induction fitting, comprising:
a fluid input; and,
a fluid output fluidly connected to the fluid input, wherein the fluid output is configured to fluidly connect to the first catalytic converter aperture; and,
a reservoir, adapted to dispense restoration material through a reservoir aperture configured to fluidly connect to the atomization and induction fitting fluid input, when restoration material is retained by the reservoir; and,
a vacuum source, configured to fluidly connect to the second catalytic converter aperture to create a pressure difference between the first catalytic converter aperture and the second catalytic converter aperture, when the vacuum source is activated.

2. The apparatus of claim 1, wherein the first catalytic converter aperture further comprises an open sensor port disposed in the catalytic converter.

3. The apparatus of claim 2, wherein the sensor port is an oxygen sensor port.

4. The apparatus of claim 1, wherein the atomization and induction fitting is removably installable into an open sensor port disposed in the catalytic converter.

5. The apparatus of claim 1, wherein the atomization and induction fitting fluid input further comprises a fluid injection tube configured to inject into the first catalytic converter aperture restoration material ingested from the reservoir.

6. The apparatus of claim 1, wherein the atomization and induction fitting further comprises:
a fluid injection tube disposed substantially parallel with the first catalytic converter aperture dimension disposed substantially conformant with the catalytic converter housing surface subsuming the aperture, and wherein the fluid injection tube is configured to inject into the first catalytic converter aperture restoration material dispensed from a connected reservoir; and,
a dispersing nozzle configured to atomize restoration material dispensed from the reservoir.

7. The apparatus of claim 6, wherein the dispersing nozzle is disposed at an angle of between approximately zero and approximately ninety degrees with respect to the fluid injection tube.

8. The apparatus of claim 6, wherein the dispersing nozzle is disposed at an angle of approximately ninety degrees with respect to the fluid injection tube.

9. The apparatus of claim 6, wherein the dispersing nozzle further includes a discharge point offset along the length of the nozzle by a linear displacement of at least one-half inch but no more than two inches.

10. The apparatus of claim 6, wherein the dispersing nozzle further includes at least one pressure relief slot disposed in the nozzle surface.

11. An apparatus, comprising:
a refurbishing system configured to restore catalytic converter performance based on atomizing and dispersing restoration material onto the catalytic converter substrate as the restoration material is ingested into a first catalytic converter aperture, when a pressure difference is created between the first catalytic converter aperture and a second catalytic converter aperture, comprising:
an atomization and induction fitting, comprising:
a fluid input, comprising: a fluid injection tube configured to inject restoration material into the first catalytic converter aperture; and,
a fluid output configured to fluidly connect to the first catalytic converter aperture through an open oxygen sensor port, the fluid output comprising:
a dispersing nozzle fluidly connected to the fluid input, wherein the dispersing nozzle is disposed at an angle of approximately ninety degrees with respect to the fluid injection tube, and wherein the dispersing nozzle further includes at least one pressure relief aperture defining a substantially rectangular slot disposed in the dispersing nozzle surface; and,
a discharge point offset by a linear displacement of at least one-half inch but not more than one and one-half inch along the length of the nozzle from the fluid input; and,
a reservoir retaining restoration material fluid, wherein the reservoir is adapted to dispense the restoration material fluid through a reservoir aperture configured to fluidly connect to the atomization and induction fitting fluid input; and,
a vacuum source, configured to fluidly connect to the second catalytic converter aperture to create a pressure difference between the at least one pressure relief aperture disposed in the dispersing nozzle surface and the second catalytic converter aperture, when the vacuum source is activated.

12. The apparatus of claim 11, wherein the fluid injection tube is disposed substantially parallel with the first catalytic converter aperture dimension that is disposed substantially conformant with the catalytic converter housing surface subsuming the aperture, and wherein the fluid injection tube is configured to inject into the first catalytic converter aperture restoration material dispensed from a connected reservoir.

13. The apparatus of claim 11, wherein the at least one pressure relief aperture disposed in the nozzle surface is disposed on the nozzle side opposite from the discharge point.

14. The apparatus of claim 11, wherein the apparatus further comprises:
a catalytic converter having a first aperture and a second aperture;
wherein the reservoir aperture is fluidly connected to the atomization and induction fitting fluid input;
wherein the atomization and induction fitting fluid output is fluidly connected to the catalytic converter first aperture; and, wherein the catalytic converter second aperture is fluidly connected to the vacuum source.

15. The apparatus of claim 11, wherein the restoration material further comprises in approximate percent by weight: 89.0 to 99.000% Water, and Palladium and or, Platinum and or Rhodium precursor solutions having between 1.0 and 11% metals contained within, either combined or individual.

16. A process, comprising:
a method to restore catalytic converter performance based on atomizing and dispersing restoration material onto the catalytic converter substrate as the restoration material is ingested into a first catalytic converter aperture, when a pressure difference is created between the first catalytic converter aperture and a second catalytic converter aperture, comprising:
configuring a fluid fitting with a dispersing nozzle adapted to disperse restoration material atomized at the nozzle discharge point;
configuring in the dispersing nozzle surface at least one pressure relief aperture defining a substantially rectangular slot;
connecting the fluid fitting to a first catalytic converter aperture;
supplying restoration material at substantially atmospheric pressure to the first catalytic converter aperture through the fluid fitting;
applying a vacuum to a second catalytic converter aperture to atomize the restoration material at the nozzle discharge point; and,
dispersing the atomized restoration material from the nozzle discharge point:onto the catalytic converter substrate.

17. The process of claim 16, wherein applying a vacuum further comprises connecting a shop vacuum cleaner to the second catalytic converter aperture.

18. The process of claim 16, wherein supplying restoration material to the first catalytic converter aperture further comprises supplying the restoration material through an open catalytic converter oxygen sensor port.

19. The process of claim 16, wherein the restoration material further comprises a precious metal composition.

20. The process of claim 16, wherein the restoration material further comprises in approximate percent by weight: 60.0% Water, 39.0% Alumina-cerium-oxide as a compound material impregnated with Lanthanum in an approximate Ratio of 1/0.999/.0001/ (Alumina/Cerium/Lanthanum), and the balance Palladium and or Platinum and or Rhodium precursor solutions having between 5.0 and 30.0% metals contained within whether individual or combined.
